(19) United States
(12) Patent Application Publication
(10) Pub. No.: US 2025/0175993 A1
(43) Pub. Date: May 29, 2025

(54) PHYSICAL DOWNLINK CONTROL CHANNEL (PDCCH) MONITORING ADAPTATION FOR TWO STAGE DOWNLINK CONTROL INFORMATION (DCI)

(71) Applicant: QUALCOMM Incorporated, San Diego, CA (US)

(72) Inventors: Huilin XU, Temecula, CA (US); Jing SUN, San Diego, CA (US); Xiao Feng WANG, San Diego, CA (US); Le LIU, San Jose, CA (US)

(21) Appl. No.: 18/519,916

(22) Filed: Nov. 27, 2023

(51) Int. Cl. H04W 72/232; H04W 72/0446; H04W 72/1273

(52) U.S. Cl. CPC H04W 72/232; H04W 72/0446; H04W 72/1273

(57) ABSTRACT

Certain aspects of the present disclosure provide techniques for physical downlink control channel (PDCCH) monitoring adaptation. A method generally includes receiving, in a downlink channel, an indication indicating to stop monitoring, after an activation time for the indication, a plurality of PDCCH monitoring occasions that an apparatus was previously scheduled to monitor, wherein at least one of the downlink channel or the plurality of PDCCH monitoring occasions is associated with at least one of a first stage downlink control information (DCI) of a two stage DCI or a second stage DCI of the two stage DCI; based on the indication, monitoring at least one PDCCH monitoring occasion of the plurality of PDCCH monitoring occasions after the activation time; and based on the indication, stopping monitoring one or more PDCCH monitoring occasions of the plurality of PDCCH monitoring occasions after the activation time.

### INTRODUCTION

### Field of the Disclosure

Aspects of the present disclosure relate to wireless communications, and more particularly, to techniques for physical downlink control channel (PDCCH) monitoring adaptation.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by an apparatus. The method includes receiving, in a downlink channel, an indication indicating to stop monitoring, after an activation time for the indication, a plurality of physical downlink control channel (PDCCH) monitoring occasions that the apparatus was previously scheduled to monitor, wherein at least one of the downlink channel or the plurality of PDCCH monitoring occasions is associated with at least one of a first stage downlink control information (DCI) of a two stage DCI or a second stage DCI of the two stage DCI; based on the indication, monitoring at least one PDCCH monitoring occasion of the plurality of PDCCH monitoring occasions after the activation time; and based on the indication, stopping monitoring one or more PDCCH monitoring occasions of the plurality of PDCCH monitoring occasions after the activation time.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIGS. 5A-5C depict example two stage downlink control information (DCI) use cases.

FIGS. 6A-6C depict example physical downlink control channel (PDCCH) monitoring behavior of a UE adapted to immediately stop monitoring PDCCH monitoring occasions that the UE was previously scheduled to monitor.

FIG. 7 depicts example problems associated with adapting PDCCH monitoring behavior of a UE configured to monitor for both single stage DCI and two stage DCI.

FIG. 8 depicts example PDCCH monitoring and adaptation for two stage DCI.

FIGS. 9A-9B depict example PDCCH monitoring behavior of a UE adapted to monitor at least a first-in-time PDCCH monitoring occasion associated with a first stage DCI of a two stage DCI after receiving a PDCCH monitoring adaptation indication.

FIGS. 10A-10C depict example PDCCH monitoring behavior of a UE adapted to monitor all PDCCH monitoring occasions associated with a first stage DCI of a two stage DCI after receiving a PDCCH monitoring adaptation indication.

FIGS. 11A-11B depict example PDCCH monitoring behavior of a UE adapted to monitor a PDCCH monitoring occasion associated with a first stage DCI of a two stage DCI after receiving a PDCCH monitoring adaptation indication.

FIG. 12 depicts example adapted PDCCH monitoring behavior of a UE after receiving a PDCCH monitoring adaptation indication for search space set group (SSSG) switching.

FIG. 13 depicts a method for wireless communications.

FIG. 14 depicts aspects of an example communications device.

### DETAILED DESCRIPTION

A user equipment (UE) may be configured to monitor for two stage downlink control information (DCI). That is, a UE may be configured to monitor for at least two DCIs (e.g., a first stage DCI and one or more second stage DCIs) to obtain scheduling information for a given downlink channel or uplink channel. Techniques for implementing use of a PDCCH monitoring adaptation indication (also simply referred to herein as “adaptation indication”) to adjust PDCCH monitoring behavior of a UE configured to monitor for at least two stage DCI remains under-explored.

As such, aspects of the present disclosure provide apparatuses, methods, processing systems, and computer-readable mediums for adapting PDCCH monitoring behavior, of a UE, for at least two stage DCI. In some cases, adapting the PDCCH monitoring behavior involves a UE monitoring at least one PDCCH monitoring occasion that the UE was instructed to stop monitoring via an adaptation indication.

For example, a PDCCH monitoring adaptation indication may be used to trigger a UE to stop monitoring one or more PDCCH monitoring occasions that the UE was previously scheduled to monitor. As used herein, a PDCCH monitoring occasion is a time interval during which a UE, such as while in a CONNECTED mode (e.g., has an established radio resource control (RRC) connection with a network entity), is expected to monitor a PDCCH for DCI.

In certain aspects, the adaptation indication includes a PDCCH skipping command instructing a receiving UE (e.g., of the adaptation indication) to skip PDCCH monitoring for a specific duration, until a next discontinuous reception (DRX) ON duration (e.g., a periodic duration of time where the UE is expected to be in an “awake”/active state to monitor a downlink channel, while during other periods of time the UE is in a “sleep” state where the downlink channel is not monitored), or within a current DRX ON duration (e.g., within the DRX cycle). In other words, an indication including a PDCCH skipping command instructs the UE to stop monitoring PDCCH monitoring occasions that are scheduled during the indicated time period.

In some other embodiments, the adaptation indication includes a search space set group (SSSG) switching command indicating that a receiving UE (e.g., of the adaptation indication) is to switch from monitoring a first SSSG to monitoring a second SSSG indicated in the PDCCH monitoring adaptation indication. An SSSG includes one or more search space sets (SSSs). For example, a UE may be configured to monitor a first SSS included in a first SSSG (e.g., along with one or more other SSSs). An SSSG switching indication received by the UE may indicate to switch from monitoring the first SSSG to monitoring the second SSSG, where the second SSSG does not include the first SSS. As such, in response to receiving the adaptation indication, the UE may stop monitoring PDCCH monitoring occasions associated with the first SSS, and correspondingly the first SSSG.

Such PDCCH monitoring adaptation techniques described above help to reduce power consumption at a UE, in some cases, in addition to UE power saving features, such as bandwidth part (BWP) adaptation and/or wake up signals (WUSs). Further, PDCCH monitoring adaptation techniques help to support new use cases, such as extended reality (XR) (including augmented reality (AR) and/or virtual reality (VR) applications), having short packet inter-arrival times (e.g., by enabling UE short-sleeps).

Despite its advantages, use of PDCCH monitoring adaptation indication techniques in cases where a UE is configured to monitor for two stage DCI, alternative to or in addition to, single stage DCI, remains under-explored. In particular, in some cases, a UE is configured to monitor for only single stage DCI. That is, a UE is configured to monitor for a single DCI to obtain all scheduling information (e.g., DCI content) for a given downlink channel (e.g., physical downlink shared channel (PDSCH)) or uplink channel (e.g., physical uplink shared channel (PUSCH)), such as for subsequent uplink and/or downlink data transmission(s). In such cases, a PDCCH monitoring adaptation indication may be carried in the single DCI, and PDCCH monitoring behavior of the UE may be immediately adapted (e.g., UE stops monitoring one or more PDCCH monitoring occasions) after an activation time for the adaptation indication. As used herein, the activation time may be a starting application time (e.g., such as a definite symbol, subframe, frame, slot, etc.) for PDCCH skipping or SSSG switching triggered by the adaptation indication. In particular, after receiving signaling including the PDCCH monitoring adaptation indication, the UE may need time to process the PDCCH monitoring adaptation indication, such as time to decode the PDCCH monitoring adaptation indication and apply the PDCCH monitoring adaptation indication to change operation at the UE. For example, the UE, after receiving the PDCCH monitoring adaptation indication may not immediately apply the PDCCH monitoring adaptation indication to stop monitoring PDCCH monitoring occasions, as it may first process the PDCCH monitoring adaptation indication in order to apply the PDCCH monitoring adaptation indication to stop monitoring PDCCH monitoring occasions. As such, the activation time for the PDCCH monitoring adaptation indication may be based on a minimum amount of time needed for the UE to process the PDCCH monitoring adaptation indication after receiving the PDDCH monitoring adaptation indication. The minimum time needed to process the PDCCH monitoring adaptation may be uniform or may vary across UEs. In cases where the minimum time to process PDCCH monitoring adaptation indications varies across UEs, minimum processing time specific to a UE receiving a PDCCH monitoring adaptation indication may be communicated between the UE and a network entity that transmitted the PDCCH monitoring adaptation indication. In some cases, communication of the minimum processing time occurs between the UE and the network entity prior to transmission of the PDCCH monitoring adaptation. In some other cases, communication of the minimum processing time occurs between the UE and the network entity after transmission of the PDCCH monitoring adaptation. In such cases, the activation time for the PDCCH monitoring adaptation indication may be further based on a minimum amount of time needed to ensure that the UE and the network entity are coordinated (e.g., in sync) regarding the activation time (e.g., a minimum amount of time to communicate and agree on the activation time).

In some other cases, however, a UE is configured to monitor for two stage DCI, in addition to or alternative to, monitoring for single stage DCI. That is, a UE may be configured to monitor for at least two DCI (e.g., a first stage DCI and one or more second stage DCIs) to obtain all scheduling information (e.g., DCI content) for a given downlink channel or uplink channel. Identification of what DCI (e.g., single stage DCI, first stage DCI of two stage DCI, and/or second stage DCI of two stage DCI) may carry a PDCCH monitoring adaptation indication and its corresponding implications is currently unknown, as well as how a UE should alter its PDCCH monitoring behavior when receiving the adaptation indication in a single stage DCI, a first stage DCI, and/or a second stage DCI. For example, whether the adaptation indication should affect both single stage DCI and two stage DCI monitoring, whether a UE should immediately stop monitoring after receiving the DCI, how to deal with scenarios where the adaptation indication is received after receiving a first stage DCI and before receiving an associated second stage DCI, and/or the like, remain under-explored.

Accordingly, aspects described herein provide techniques for (1) communicating (e.g., sending and/or obtaining, such as transmitting and/or receiving) PDCCH monitoring adaptation indications and (2) adapting PDCCH monitoring behavior, based on such indications, when a UE is configured to monitor for two stage DCI or for both two stage DCI and single stage DCI. For example, aspects described herein provide techniques for using any scheduling DCI(s), such as a single stage DCI, a first stage DCI of a two stage DCI, and/or a second stage DCI of the two stage DCI, to carry a PDCCH monitoring adaptation indication. The PDCCH monitoring adaptation indication may be a PDCCH skipping command or an SSSG switching command.

In certain aspects, in response to receiving an indication, a UE immediately adjusts the monitoring behavior of the UE based on the adaptation indication. For example, where the adaptation indication is for PDCCH skipping, the UE may immediately stop monitoring (e.g., after an activation time for the adaptation indication) PDCCH monitoring occasions associated with single stage DCI (e.g., where the UE is configured to monitor for both single stage and two stage DCI), first stage DCI, and/or second stage DCI. As another example, where the adaptation indication is for SSSG switching (e.g., indicating to switch monitoring from a first SSSG to a second SSSG), the UE may immediately stop monitoring (e.g., after an activation time for the adaptation indication) PDCCH monitoring occasions associated with the first SSSG.

Alternatively, in certain aspects, in response to receiving an indication, a UE may monitor at least one PDCCH monitoring occasion (e.g., for a second stage DCI or a first stage DCI) and stop monitoring other PDCCH monitoring occasions occurring during a time period indicated in the adaptation indication (e.g., where the adaptation indication includes a PDCCH skipping command) or associated with an SSSG not indicated by the adaptation indication (e.g., where the adaptation indication includes an SSSG switching command). This behavior may include cases where a UE receives a first stage DCI of a two stage DCI and subsequently receives the adaptation indication (e.g., in a single stage DCI, in another first stage DCI of another two stage DCI, in a second stage DCI of the two stage DCI, or another two stage DCI, etc.). In particular, by monitoring for at least one second stage DCI in a PDCCH monitoring occasion that the UE was instructed to stop monitoring after activation of the adaptation indication, the UE may receive the second stage DCI associated with the previously-received first stage DCI. Information from at least the first stage DCI and the second stage DCI may be used by the UE for a data transmission scheduled by the first and second stage DCIs. As such, data intended for, or expected to be transmitted by, the UE may be communicated, and overhead resulting from transmitting the first stage DCI may not be wasted.

Certain aspects herein are discussed with respect to communicating PDCCH monitoring adaptation indications via a PDCCH. However, it should be noted that the techniques discussed herein are also applicable to PDCCH monitoring adaptation indication transmission via different channel types, such as a physical downlink shared channel (PDSCH) or another downlink channel.

Aspects described herein enable the use of PDCCH monitoring adaptation indications to reduce PDCCH monitoring behavior of a UE configured to monitor for at least two stage DCI. As such, power savings when using PDCCH monitoring adaptation indications (e.g., described above) may be realized, as well as advantages from implementing two stage DCI, including, for example, increased available downlink and/or uplink processing time for a scheduled downlink and/or uplink data transmission, control overhead reduction, robust and efficient transmission capabilities, and/or reduced blind decoding at a receiving UE, as described in detail below.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

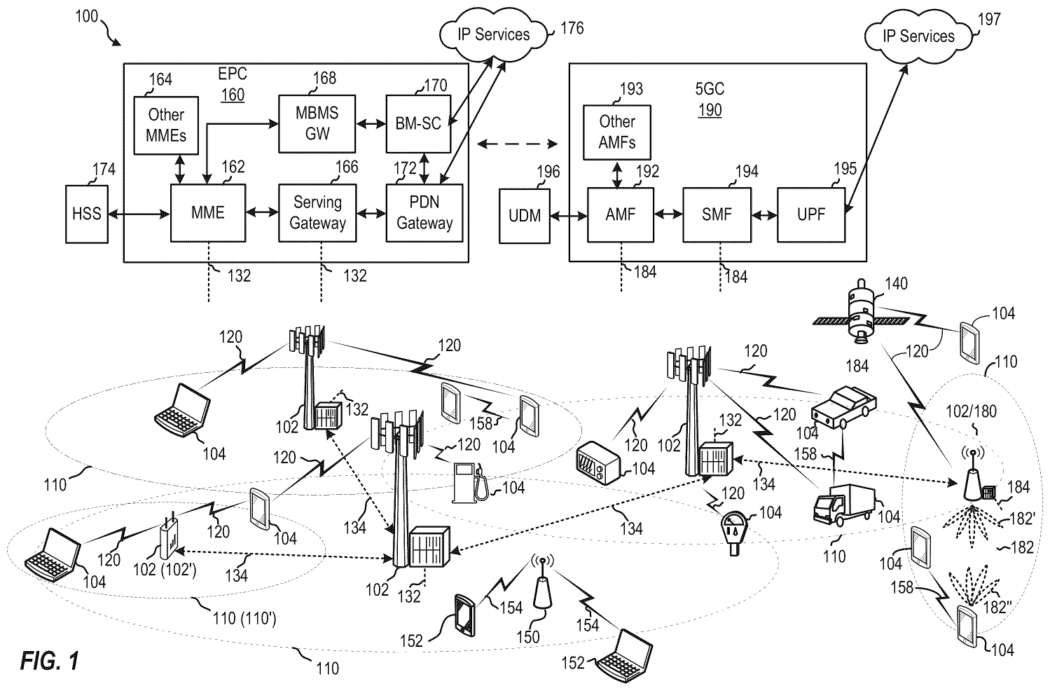

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and transporter, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

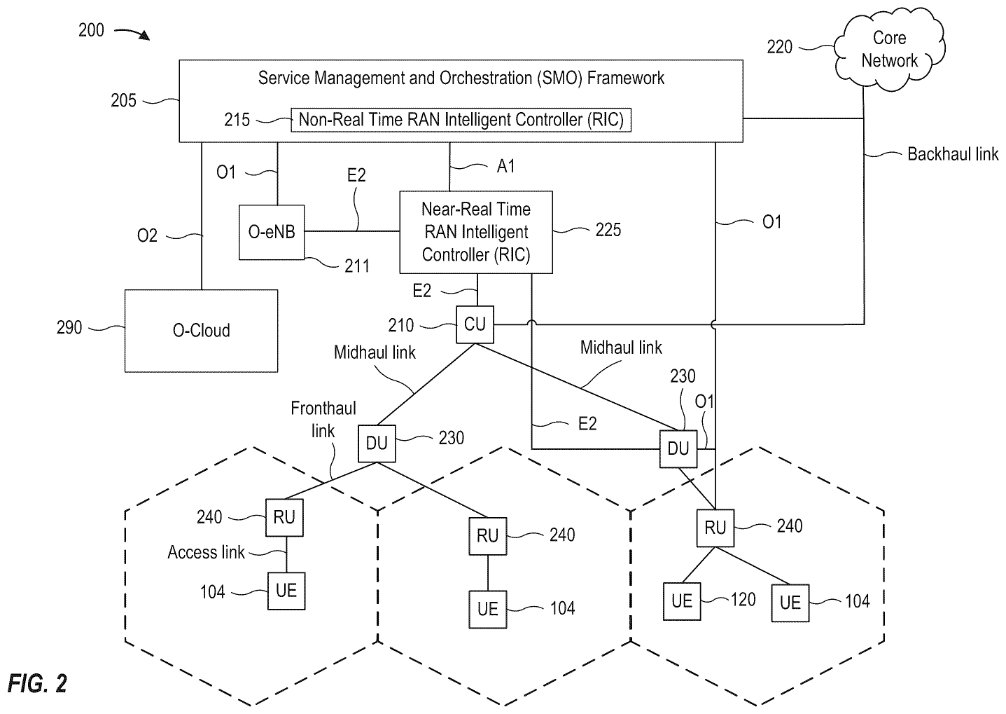

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an Si interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit—User Plane (CU-UP)), control plane functionality (e.g., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

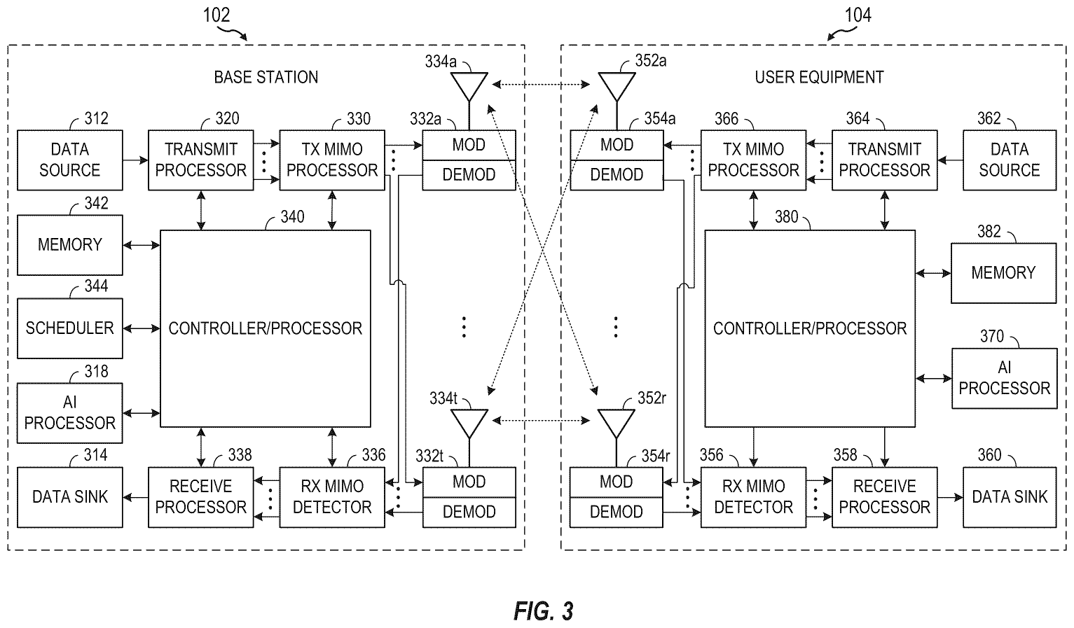

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., global navigation satellite system (GNSS) positioning). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

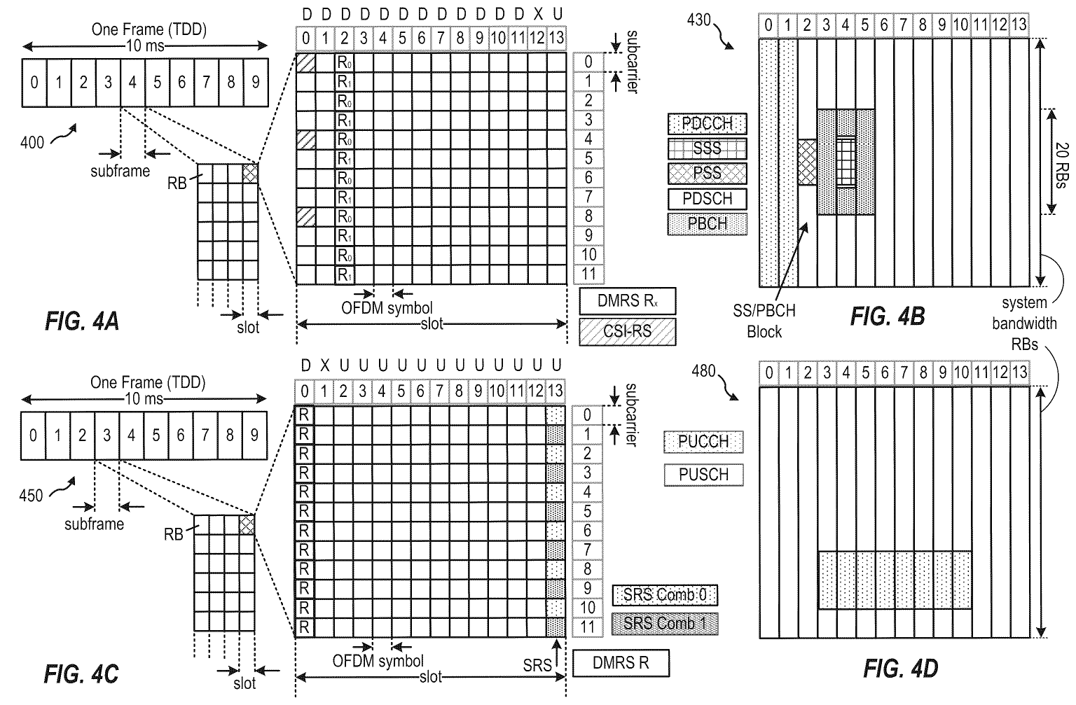

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 2^{μ}×15 kHz, where μ is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to PDCCH Monitoring and Adaptation

The PDCCH may carry DCI. DCI may be transmitted to one UE or a group of UEs on the PDCCH. DCI may contain (1) scheduling information for uplink and/or downlink data channels, e.g., resource assignments for uplink and/or downlink data and control information, (2) instructions related to hybrid automatic repeat request (HARQ) (e.g., a mechanism for error detection and re-transmission), (3) useful information for adjusting uplink power for power control, and/or (4) other signaling. A number of different DCI formats may be defined where each DCI format may serve a different purpose/usage, for example, scheduling of uplink data (e.g., on the physical uplink shared channel (PUSCH)) and/or downlink data (e.g., on the PDSCH). In certain aspects, a DCI format specifies an ordered set of bit fields, where each field conveys distinct transmission information, such as the frequency resource assignment for a data transmission, the time resource assignment for the data transmission, a redundancy version (RV), and/or a modulation and coding (MCS) (e.g., specifies the modulation scheme and coding rate to be used by the UE(s) for decoding downlink data).

DCI may be transmitted to a UE (e.g., via a PDCCH) using resource elements (REs) within a control resource set (CORESET) (e.g., a set of physical resources within a specific area of the downlink resource grid). A UE, intended to receive the DCI, may monitor PDCCH monitoring occasions within a search space set (SSS) that is mapped to the CORESET within which the DCI is transmitted, in order to detect and decode the DCI. For example, a UE may be configured with up to 40 SSSs, where each SSS has an index of 0-39. In certain aspects, each SSS configuration provides a UE with an SSS type (e.g., a common SSS (CSSS) or UE-specific SSS (USSS)), DCI format(s) to be monitored, and/or PDCCH monitoring occasion(s) to monitor for receiving DCI (e.g., a monitoring pattern for PDCCH monitoring occasions).

A PDCCH monitoring occasion may be a specific time interval during which a UE, such as while in a CONNECTED mode, is expected to monitor the PDCCH, such as for DCI. The frequency of PDCCH monitoring occasions for which the UE may monitor for DCI may be based on a PDCCH monitoring periodicity. Different SSS configured at the UE may have different PDCCH monitoring periodicities. For example, a PDCCH monitoring periodicity for a first SSS (e.g., belonging to a first SSSG including multiple SSSs and the first SSS) may be larger than a PDCCH monitoring periodicity for a second SSS (e.g., belonging to a second SSSG including multiple other SSSs and the second SSS) and thus include sparser PDCCH monitoring occasions (e.g., less occasions with a larger time between each occasion).

A UE may be configured to monitor one or more PDCCH monitoring occasions in each slot in the time-domain (e.g., based on information included in one or more SSSs configured at the UE) to decode the PDCCH in each slot. More specifically, with the received information included in a configured SSS at the UE, the UE can apply blind decoding (e.g., UE attempts the decoding of a set of candidates to identify if one of the candidates holds its control information) to detect corresponding DCI, which may include scheduling information for uplink and/or downlink data, in each slot. Based on receiving the DCI, the UE may have sufficient information to continue to receive and/or transmit on other channels, such as the PDSCH and/or the PUSCH.

Requiring UEs to monitor PDCCH occasions for DCI in every slot is a contributor to power consumption at the UE. As such, several power saving techniques, such as BWP-based bandwidth adaptation (e.g., PDCCH monitoring reduction, MIMO layer adaptation, secondary cell (SCell) dormancy, and cross-slot scheduling), wake-up signals (WUSs) for CONNECTED mode discontinuous reception (C-DRX), and UE assistance information (UAI), were introduced. Another power saving technique includes use of a PDCCH monitoring adaptation indication as discussed herein.

In particular, a PDCCH monitoring adaptation indication may be sent to a UE, such as in a DCI, and more specifically a scheduling DCI for scheduling unicast and/or multicast data. The adaptation indication may be used to trigger PDCCH skipping and/or SSSG switching at the UE to reduce PDCCH monitoring at the UE. Power for data channel demodulation may be adjusted accordingly when transmitting the PDCCH skipping and/or the SSSG switching indication.

For example, an adaptation indication used to trigger PDCCH skipping may trigger a UE, receiving the corresponding adaptation indication, to skip (e.g., stop) monitoring one or more PDCCH monitoring occasions that the UE was previously scheduled to monitor. The one or more PDCCH monitoring occasions may occur in time during a time period, indicated by the adaptation indication, after an activation time of the adaptation indication, On the other hand, an adaptation indication used to trigger SSSG switching may trigger a UE, receiving the indication, to stop monitoring PDCCH monitoring occasions associated with a current SSSG and start monitoring PDCCH monitoring occasions associated with a target (e.g., an indicated) SSSG (e.g., switch from the current SSSG to the target SSSG after an activation time of the adaptation indication received by the UE). In some cases, such SSSG switching is used to cause the UE to monitor less PDCCH monitoring occasions by switching from an SSSG associated with denser PDCCH monitoring occasions (e.g., a larger amount of occasions with smaller periodicity) to an SSSG associated with sparser PDCCH monitoring occasions (e.g., a smaller amount of occasions with larger periodicity). As such, using either indication, a UE may monitor for less PDCCH monitoring occasions than the UE was originally scheduled to monitor, thereby reducing power consumption at the UE. Further, a UE may switch between different PDCCH monitoring efforts, to invoke power savings at different times, based on one or more adaptation indications.

### Aspects Related to Single Stage DCI and Two Stage DCI

In some implementations, a UE is configured to monitor for only single stage DCI. That is, a UE is configured to monitor for a single DCI to obtain all scheduling information (e.g., DCI content) for a downlink channel or an uplink channel. In some cases, the single stage DCI design provides flexibility for scheduling various services with different quality of service (QoS) requirements.

In some other implementations, a UE is configured to monitor for two stage DCI, in addition to or alternative to, monitoring for single stage DCI. Unlike single stage DCI, with two stage DCI, a UE is configured to monitor for at least two DCIs (e.g., a first stage DCI and one or more second stage DCIs) to obtain all scheduling information (e.g., DCI content) for a downlink channel or an uplink channel. For example, a network entity may transmit, to a UE, a first stage DCI and a second stage DCI associated with the first stage DCI (e.g., which together make up a two stage DCI). The second stage DCI may be “associated” with the first stage DCI in that the first stage DCI and second stage DCI may each contain scheduling information associated with a single downlink or uplink channel, such as a single downlink or uplink data transmission. The UE may be configured to monitor for two stage DCI, and thus may monitor for both the first stage DCI and the second stage DCI transmitted by network entity. Based on the monitoring, the UE may detect and decode both the first stage DCI and second stage DCI and collectively use the information contained in the first and second stage DCIs to receive downlink data or transmit uplink data from/to the network entity.

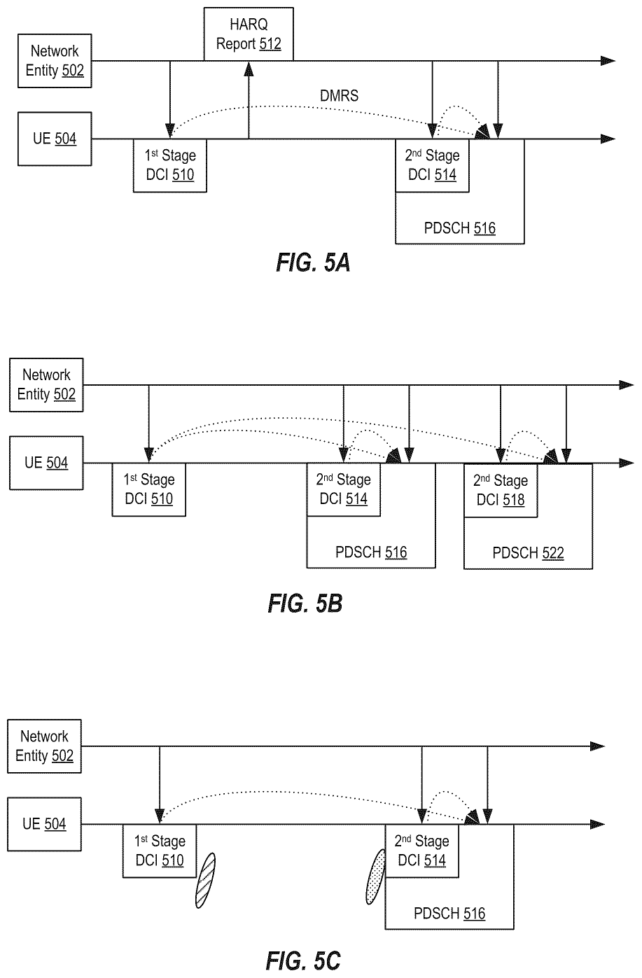

Configuring the UE to monitor for two stage DCI may be useful in various cases, including, for example, the cases illustrated in FIGS. 5A-5C.

For example, in FIG. 5A, utilizing a two stage DCI may provide additional downlink processing time for an upcoming downlink data transmission. In particular, as shown, a network entity 502 (e.g., such as BS 102 in FIGS. 1 and 3) transmits, to a UE 504 (e.g., such as UE 104 in FIGS. 1 and 3), a first stage DCI 510 and a second stage DCI 514 (e.g., associated with first stage DCI 510). Both first stage DCI 510 and second stage DCI 514 may be used to schedule resources for a downlink data transmission (e.g., PDSCH 516). The first stage DCI 510 may be transmitted earlier in time than the second stage DCI 514, which is transmitted closer in time to when the downlink data transmission (e.g., PDSCH 516) is scheduled. For example, first stage DCI 510 may be transmitted prior in time than when a HARQ report 512 (e.g., HARQ acknowledgement (ACK)/negative ACK (NACK) feedback) is expected to be transmitted by UE 504 for a previous data transmission (e.g., previous data transmitted via PDSCH). By scheduling downlink resources for the downlink data transmission prior to receiving HARQ feedback for a previous data transmission, UE 504 may be able to start demodulation reference signal (DMRS) processing and channel estimation prior to receiving second stage DCI 514.

FIG. 5B further depicts how utilization of a two stage DCI may be useful for control overhead reduction. In particular, as shown in FIG. 5B, network entity 502 transmits, to UE 504, a first stage DCI 510 and multiple second stage DCIs (e.g., second stage DCI 514 and second stage DCI 518). First stage DCI 510 may provide common scheduling information for multiple transmissions (e.g., PDSCH 516 and PDSCH 522), while each second stage DCI 514, 518 provides link adaptation scheduling information. By using the first stage DCI 510 to carry scheduling information for multiple transmissions, multiple DCI transmissions carrying similar information may be avoided, thereby reducing control information transmission overhead.

FIG. 5C further depicts how utilization of a two stage DCI may allow for a more robust transmission of the first stage DCI and a more spectral efficient transmission of the second stage DCI. For example, as shown in FIG. 5C, network entity 502 transmits, to UE 504, a first stage DCI 510 and a second stage DCI 514. Both first stage DCI 510 and second stage DCI 514 may be used to schedule resources for a downlink data transmission (e.g., PDSCH 516). First stage DCI 510 may be transmitted to UE 504 via a first beam, or a wide beam (e.g., an unrefined beam or a beam having a beam width that satisfies a first threshold), while second stage DCI 514 may be transmitted to UE 504 via a second beam, or a narrow beam (e.g., a refined beam or a beam having a beam width that satisfies a second threshold and the first threshold). Reference to wide beam and narrow beam may be relative to one another, such that a wide beam has a relatively wider beam, while a narrow beam has a relatively narrower beam.

Beyond the use cases illustrated in FIGS. 5A-5C, utilization of a two stage DCI may also allow for increased uplink processing time at a UE receiving the first and second stage DCIs. For example, the UE may begin preparing uplink data for transmission immediately after receiving the first stage DCI, having minimal information. As such, transmission of this uplink data may be transmitted directly after the second stage DCI is decoded by the UE. Utilization of a two stage DCI may also help to reduce blind decoding at the UE. In particular, DCI size may be aligned among different first stage DCI formats that require blind decoding.

Implementing both single stage DCI (e.g., NR single stage DCI) and two stage DCI designs, such that a UE is configured to monitor for both single stage DCI and DCI of two stage DCI, may allow for the realization of advantages associated with both implementations, as described above. However, techniques for building the two stage DCI design on the top of single stage DCI designs (e.g., including CORESET, SSS, PDCCH monitoring occasions, PDCCH candidates, various DCI formats, DCI size alignment, blind decoding limits, control channel element (CCE) limits, PDCCH monitoring skipped conditions, etc.), including techniques for implementing use of PDCCH monitoring adaptation indications, remains under-explored.

For example, when a UE is configured to monitor for single stage DCI only, a PDCCH monitoring adaptation indication may be carried in a single stage DCI to initiate PDCCH skipping and/or SSSG switching by one or more receiving UEs. The PDCCH monitoring adaptation indication may cause the receiving UE(s) to immediately stop monitoring PDCCH monitoring occasions (e.g., for a specified time period or not associated with an indicated target SSSG), such as for DCI, after an activation time of the adaptation indication.

In cases where a UE is configured to monitor for single stage DCI and two stage DCI, however, it is unclear whether a PDCCH monitoring adaptation indication should be carried in a single stage DCI, a first stage DCI of a two stage DCI, or a second stage DCI of a two stage DCI, and what the implications are for each scenario. Further, it is under-explored how a UE should operate when receiving a PDCCH monitoring adaptation indication carried in a single stage DCI, a first stage DCI, or a second stage DCI, for example, whether the adaptation indication should affect both single stage DCI and two stage DCI monitoring, whether a UE should immediately stop monitoring after receiving the DCI, how to deal with scenarios where the adaptation indication is received after receiving a first stage DCI and before receiving an associated second stage DCI, and/or the like.

As such, techniques for PDCCH monitoring and adaptation for cases where a UE is configured to monitor for at least two stage DCI are desired.

### Example Aspects Related to PDCCH Monitoring for Two Stage DCI

Aspects described herein provide techniques for adapting PDCCH monitoring for single stage DCI and/or two stage DCI using PDCCH monitoring adaptation indications. As described above, a PDCCH monitoring adaptation indication may be sent in a downlink channel (e.g., PDCCH, PDSCH, etc.), such as in a scheduling DCI, and used to trigger PDCCH skipping and/or SSSG switching at a receiving UE. More specifically, the adaptation indication triggering PDCCH skipping and/or SSSG switching (e.g., to an SSSG associated with sparser PDCCH monitoring occasions) may trigger a UE to stop monitoring (e.g., after an activation time for the adaptation indication) one or more PDCCH monitoring occasions that the UE was previously scheduled to monitor (e.g., after an activation time for the adaptation indication) to thereby adapt monitoring behavior (e.g., reduce monitoring by the UE) and improve power consumption at the UE. In some other cases, the adaptation indication triggering SSSG switching (e.g., to an SSSG associated with denser PDCCH monitoring occasions) may trigger a UE to stop monitoring (e.g., after an activation time for the adaptation indication) sparser (e.g., less frequent) PDCCH monitoring occasions associated with a first SSSG and begin monitoring denser (e.g., more frequent) PDCCH monitoring occasions associated with a second SSSG to thereby adapt monitoring behavior (e.g., increase the frequency of monitoring by the UE) and improve the reliability of communication between the UE and a network entity transmitting the adaptation indication.

According to some embodiments described herein, the PDCCH monitoring adaptation indication may be carried in a scheduling DCI, such as a single stage DCI, a first stage DCI of a two stage DCI, or a second stage DCI of the two stage DCI. For example, where a UE is configured to monitor for two stage DCI only, a PDCCH monitoring adaptation indication may be carried in (1) a first stage DCI of the two stage DCI only, (2) a second stage DCI of the two stage DCI only, or (3) both the first and second stage DCIs. Alternatively, where a UE is configured to monitor for both single stage DCI and two stage DCI, a PDCCH monitoring adaptation indication may be carried in (1) the single stage DCI only, (2) a first stage DCI of the two stage DCI only, (3) a second stage DCI of the two stage DCI only, (4) both the first and second stage DCIs, or (5) in each of the single stage DCI, the first stage DCI, and the second stage DCI.

Beyond carrying the adaptation indication in single stage DCI, there may be benefits to carrying the adaptation indication in the first stage DCI, the second stage DCI, or in both the first and second stage DCIs (e.g., where a UE is configured to monitor for two stage DCI). For example, using the first stage DCI to carry the adaptation indication may allow a receiving UE to immediately start the indicated PDCCH monitoring adaptation behavior triggered via the adaptation indication. Skipping monitoring one or more PDCCH monitoring occasions earlier in time, where no control information is expected, may further increase power savings at the UE. Further, switching to monitoring DCI in an SSSG associated with more dense/frequent PDDCH monitoring occasions earlier in time, based on receiving the adaptation indication in the first stage DCI, may help to minimize delay in switching at the UE. Alternatively, using the second stage DCI, instead of the first stage DCI, to carry the adaptation indication may allow a network entity transmitting the DCI to fine tune PDCCH monitoring adaptation timing. For example, if a first stage DCI is associated with multiple second stage DCIs, which are to be sent in sequential PDCCH monitoring occasions, the network entity may send the adaptation indication in a first-in-time second stage DCI, a second-in-time second stage DCI, a third-in-time second stage DCI, etc. As such, the network entity may be able to choose a timing for when the adaptation is to be sent to the UE, and thus applied by the UE upon receipt of the second stage DCI carrying the adaptation indication. Lastly, using both the first stage DCI and the second stage DCI to carry the adaptation indication may help to achieve the advantages associated with carrying the adaptation indication in the first stage DCI and the advantage associated with carrying the adaptation indication in the second stage DCI, however, with additional overhead.

In certain aspects, after receiving a DCI (e.g., a single stage DCI, a first stage DCI of a two stage DCI, and/or a second stage DCI of a two stage DCI) comprising an adaptation indication, the UE immediately adjusts the monitoring behavior of the UE based on the adaptation indication. For example, where the adaptation indication is for PDCCH skipping, the UE may immediately stop monitoring (e.g., after an activation time for the adaptation indication) PDCCH monitoring occasions associated with one or more single stage DCI, one or more first stage DCI, and/or one or more second stage DCI (e.g., regardless of where the adaptation indication is received, such as in a single stage DCI, or first or second stage DCI). Alternatively, where the adaptation indication is for SSSG switching, indicating to switch from monitoring PDCCH monitoring occasions associated with a first SSSG to monitoring PDCCH monitoring occasions associated with a second SSSG, the UE may immediately stop monitoring (e.g., after an activation time for the adaptation indication) PDCCH monitoring occasions associated with the first SSSG (e.g., and associated with one or more single stage DCI, one or more first stage DCI, and/or one or more second stage DCI) and begin monitoring PDCCH monitoring occasions associated with the second SSSG (e.g., and associated with one or more single stage DCI, one or more first stage DCI, and/or one or more second stage DCI).

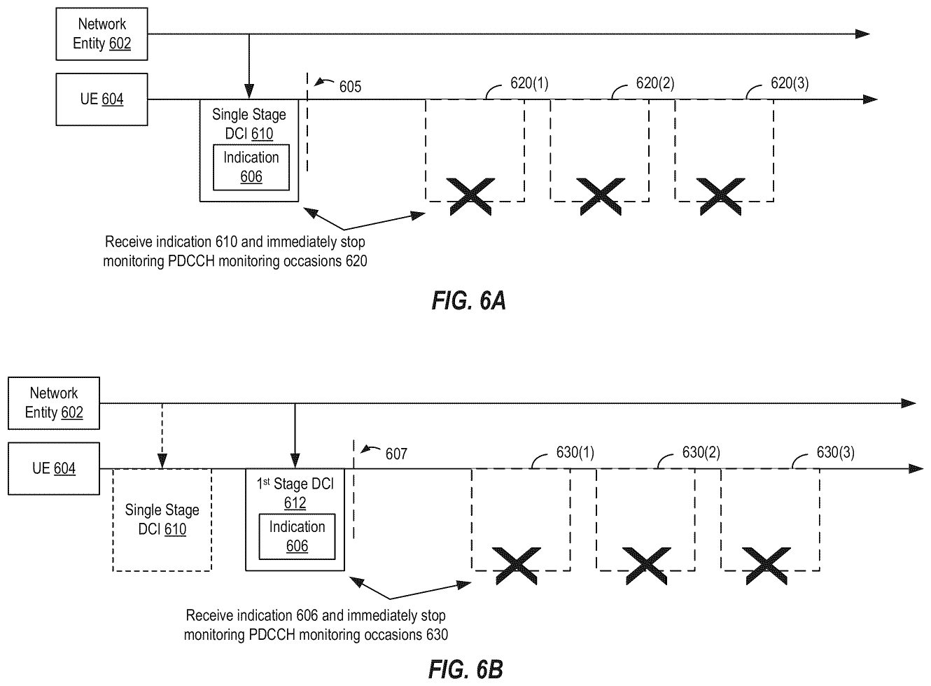

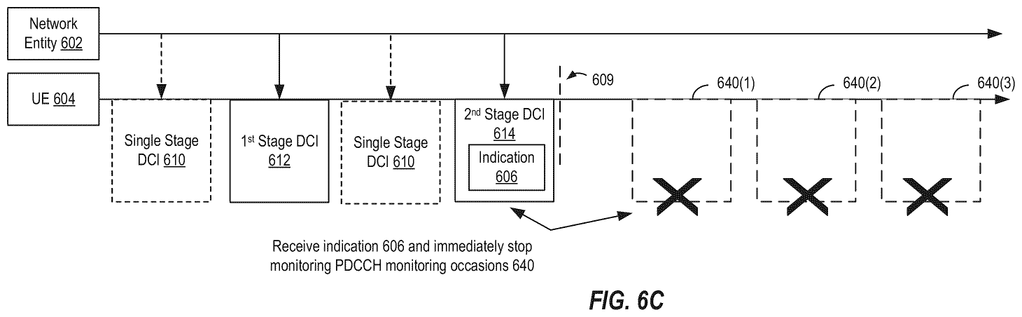

FIGS. 6A-6C depict example PDCCH monitoring behavior of a UE adapted to immediately stop monitoring PDCCH monitoring occasions that the UE was previously scheduled to monitor. FIGS. 6A-6C depicts example scenarios where the PDCCH monitoring adaptation indication (e.g., indication 606) is carried in a single stage DCI 610, a first stage DCI 612, and a second stage DCI 614 (e.g., via a PDCCH), respectively. The adaptation indication may be used to trigger PDCCH skipping or SSSG switching.

As shown in FIG. 6A, a network entity 602 (e.g., such as BS 102 in FIGS. 1 and 3) transmits, to a UE 604 (e.g., such as UE 104 in FIGS. 1 and 3), a single stage DCI 610. UE 604 may be configured to monitor for both single stage DCI and two stage DCI, and thus based on this configuration, monitor for and receive/detect single stage DCI 610. UE 604 may receive single stage DCI 610 prior to receiving a first stage DCI and a second stage DCI of a next-in-time two stage DCI (e.g., DCIs for a previous two stage DCI may have been sent prior to receiving the single stage DCI 610), such as scheduled in one or more PDCCH monitoring occasions 620 the UE 604 was previously scheduled to monitor. Single stage DCI 610 includes an indication 606 triggering PDCCH skipping or SSSG switching for PDCCH monitoring at UE 604. Thus, in response to receiving indication 606 and after activation time 605 of indication 606, UE 604 stops monitoring PDCCH monitoring occasions 620, which UE 604 was previously scheduled to monitor. In some cases, PDCCH monitoring occasions 620 are monitoring occasions that fall within a time period after activation time 605 of indication 606, where indication 606 is a PDCCH skipping command for the time period. These PDCCH monitoring occasions 620 may be monitoring occasions that UE 604 uses to monitor for single stage DCI, first stage DCI, and/or second stage DCI. Although not shown in FIG. 6A, after the time period is complete, UE 604 may again begin monitoring PDCCH monitoring occasions that UE 604 is scheduled to monitor. In some other cases, PDCCH monitoring occasions 620 are monitoring occasions associated with an SSSG previously monitored by UE 604 prior to receiving indication 606.

Unlike FIG. 6A, in FIG. 6B, indication 606 is carried in first stage DCI 612 (e.g., instead of single stage DCI 610). In some cases, first stage DCI 612, including indication 606, is transmitted, by network entity 602 to UE 604, after transmitting a single stage DCI 610 to UE 604. Similar to FIG. 6A, in FIG. 6B, in response to receiving indication 606 and after an activation time 607 of indication 606, UE 604 stops monitoring PDCCH monitoring occasions 630, which UE 604 was previously scheduled to monitor. PDCCH monitoring occasions 630 may be monitoring occasions occurring during a time period after activation time 607 of indication 606 or monitoring occasions associated with an SSSG that UE 604 was previously scheduled to monitor (e.g., prior to activation time 607 of indication 606). These PDCCH monitoring occasions 630 may be monitoring occasions that UE 604 uses to monitor for single stage DCI, first stage DCI, and/or second stage DCI. In certain aspects, indication 606, carried in first stage DCI 612, may indicate to adapt a monitoring behavior of UE 604 when monitoring for two stage DCI, but not single stage DCI. Thus, the PDCCH monitoring occasions 630 may be monitoring occasions that UE 604 uses to monitor for first stage DCI and/or second stage DCI, while monitoring of PDCCH monitoring occasions for single stage DCI remains unchanged.

Unlike FIGS. 6A and 6B, in FIG. 6C, indication 606 is carried in second stage DCI 614 (e.g., instead of single stage DCI 610 and/or first stage DCI 612). Second stage DCI 614 is transmitted, by network entity 602 to UE 604, after transmitting first stage DCI 612 (e.g., where second stage DCI 614 is associated with first stage DCI 612) to UE 604. Additionally, in some cases, second stage DCI 614, including indication 606, is transmitted, by network entity 602 to UE 604, after transmitting a single stage DCI 610 to UE 604 before or after transmitting first stage DCI 612. Similar to FIGS. 6A and 6B, in FIG. 6C, in response to receiving indication 606 and after an activation time 609 of indication 606, UE 604 stops monitoring PDCCH monitoring occasions 640, which UE 604 was previously scheduled to monitor. PDCCH monitoring occasions 640 may be monitoring occasions occurring during a time period after activation time 609 of indication 606 or monitoring occasions associated with an SSSG that UE 604 was previously scheduled to monitor after activation time 609 of indication 606. These PDCCH monitoring occasions 640 may be monitoring occasions that UE 604 uses to monitor for single stage DCI, other first stage DCI, and/or second stage DCI.

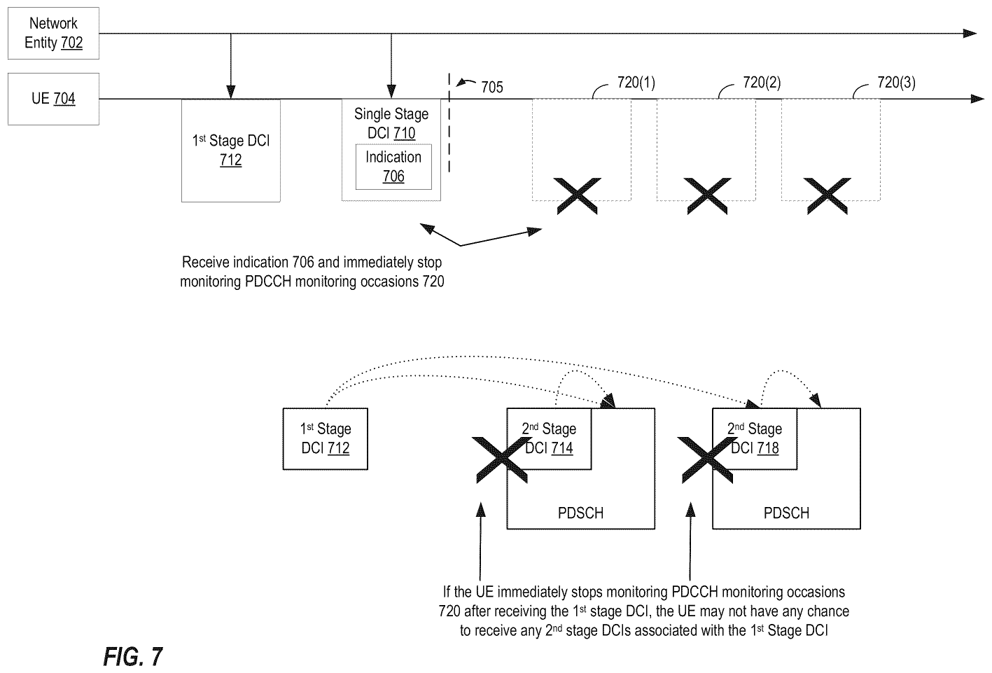

In some cases, a PDCCH monitoring adaptation indication is carried in a single stage DCI transmitted later in time than when a first stage DCI is transmitted, but prior in time to transmitting a second stage DCI. For example, as shown in FIG. 7, a single stage DCI 710, transmitted by a network entity 702 (e.g., such as BS 102 in FIGS. 1 and 3) to a UE 704 (e.g., such as UE 104 in FIGS. 1 and 3), is used to carry an indication 706 (e.g., for PDCCH skipping or SSSG switching). Single stage DCI 710 may be received by UE 704 after UE 704 receives a first stage DCI 712, but before UE 704 receives a second stage DCI associated with first stage DCI 712. Based on receiving indication 706 in single stage DCI 710 and after an activation time 705 of indication 706, UE 704 immediately stops monitoring PDCCH monitoring occasions 720. However, if UE 704 immediately stops monitoring PDCCH monitoring occasions 720 after activation time 705 of indication 706 (and after receiving first stage DCI 712), UE 704 may not receive any second stage DCI associated with first stage DCI 712 (e.g., may not receive second stage DCI 714 and second stage DCI 718 shown in FIG. 7 as being associated with first stage DCI 712). In other words, where one or more PDCCH monitoring occasions 720 are used for monitoring for second stage DCI, and UE 704 immediately stops monitoring PDCCH monitoring occasions 720 after activation time 705 of indication 706, then UE 704 may not receive a second stage DCI associated with an already-received first stage DCI 712 (e.g., scheduling a downlink or uplink data transmission). As such, UE 704 may not have all the necessary information needed to receive the downlink data transmission or transmit the uplink data transmission at least partially scheduled by first stage DCI 712. Further, transmission of the previously-received first stage DCI 712 may have been unnecessary (e.g., waste of resources).

Similar problems may also be encountered when the PDCCH monitoring adaptation indication is carried (1) in the first stage DCI, (2) in a single stage DCI transmitted at the same time as when the first stage DCI is transmitted (e.g., transmitted in a same PDCCH monitoring occasion associated with the first stage DCI), or (3) in a first stage DCI or a second stage DCI of another two stage DCI transmitted later in time than, or at the same time as, when the first stage DCI is transmitted. In other words, similar problems may be encountered when a PDCCH monitoring adaptation indication is transmitted before a PDCCH monitoring occasion associated with a second stage DCI that is associated with a previously-sent first stage DCI of a two stage DCI.

To overcome problems associated with receiving a PDCCH monitoring adaptation indication when or after receiving a first stage DCI and before receiving a second stage DCI (e.g., as depicted and described with respect to FIG. 7), in certain aspects, a UE may monitor for at least one PDCCH monitoring occasion, associated with a second stage DCI of a two stage DCI, after an activation time for a PDCCH monitoring adaptation indication indicating to not monitor for DCI in the at least one PDCCH monitoring occasion. In other words, the adaptation indication may trigger the UE to stop monitoring a plurality of monitoring occasions, yet the UE may continue monitoring at least one of these monitoring occasions associated with a second stage DCI associated with a previously-received first stage DCI (e.g., irrespective of what the adaptation indication is instructing the UE to do).

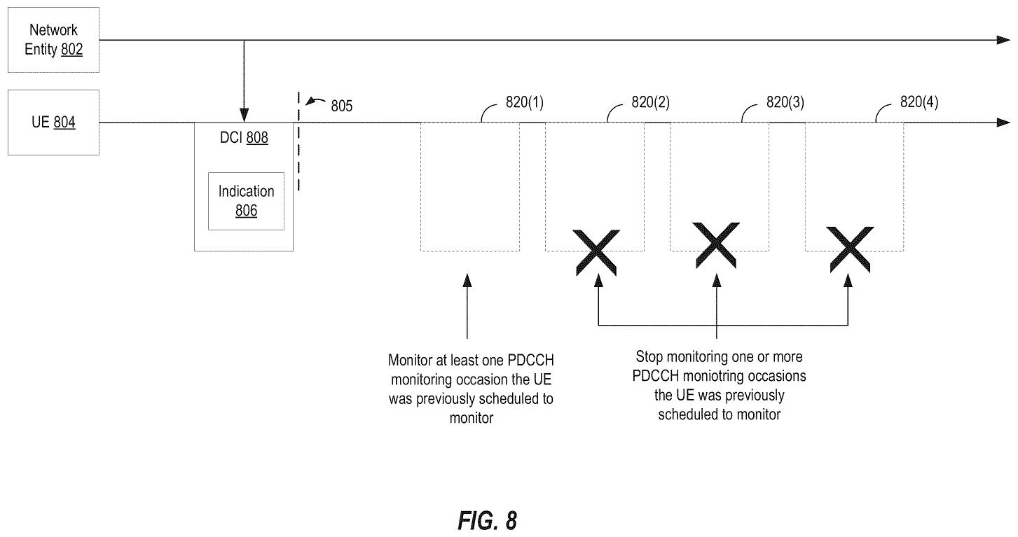

FIG. 8 depicts such PDCCH monitoring adaptation after receiving a PDCCH monitoring adaptation indication. As shown, a network entity 802 (e.g., such as BS 102 in FIGS. 1 and 3) transmits, to a UE 804 (e.g., such as UE 104 in FIGS. 1 and 3), a DCI 808 scheduling a data transmission (e.g., an uplink data transmission or a downlink data transmission, not shown in FIG. 8). DCI 808 may be a single stage DCI, a first stage DCI, or a second stage DCI. In some cases, DCI 808 is a single stage DCI received by UE 804 after receiving a first stage DCI, but before receiving a second stage DCI associated with the first stage DCI.

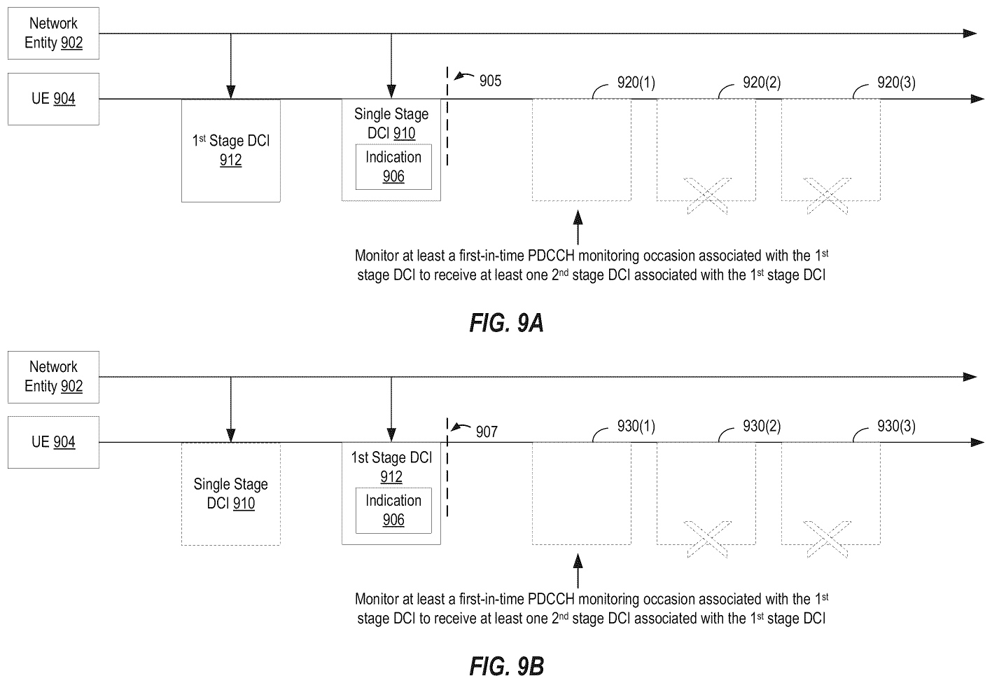

DCI 808 includes an indication 806 (e.g., a PDCCH skipping indication or an SSSG switching indication) indicating to stop monitoring a plurality of PDCCH monitoring occasions, such as PDCCH monitoring occasions 820 (e.g., indicating to stop monitoring PDCCH monitoring occasions 820(1)-820(4)) that UE 804 was previously scheduled to monitor. Based on receiving DCI 808 (e.g., via a PDCCH), UE 804 (1) monitors at least one PDCCH monitoring occasion 820 and (2) stops monitoring one or more of PDCCH monitoring occasions 820. Specifically, in this example, UE 804 monitors PDCCH monitoring occasion 820(1) (e.g., an occasion associated with a second stage DCI) and stops monitoring PDCCH monitoring occasions 820(2)-820(4) after an activation time 805 of indication 806. In some other examples, UE 804 additionally monitors for PDCCH monitoring occasions 820(2), 820(3), and/or 820(4) and stops monitoring PDCCH monitoring occasions 820(3) and/or 820(4). In some other examples, UE 804 may simultaneously monitor for at least one PDCCH monitoring occasion that the indication 806 indicated to stop monitoring and stops monitoring for other PDCCH monitoring occasions that the indication 806 indicates to stop monitoring. Monitoring for at least one PDCCH monitoring occasion 820 that UE 804 was instructed to stop monitoring (e.g., based on receiving indication 806 and after an activation time 805 of indication 806) may enable UE 804 to receive a second stage DCI when the indication 806 is received in a single stage DCI after receiving a first stage DCI or when the indication 806 is received in an associated first stage DCI. Additional details for monitoring at least one PDCCH monitoring occasion, after being instructed to stop monitoring for a plurality of PDCCH monitoring occasions including the at least one PDDCH monitoring occasion, are provided below with respect to FIGS. 9A-9B, 10A-10C, 11A-11B, and 12.

For example, in certain aspects, the at least one PDCCH monitoring occasion monitored by a UE after an activation time of a PDDCH monitoring adaptation indication is a PDCCH monitoring occasion associated with a previously received (e.g., at a UE) first stage DCI that occurs first-in-time after receiving the adaptation indication. For example, the at least one PDCCH monitoring occasion is scheduled to carry a second stage DCI associated with the first stage DCI. FIGS. 9A-9B depict example PDCCH monitoring behavior of a UE adapted to monitor at least a first-in-time PDCCH monitoring occasion associated with a first stage DCI of a two stage DCI after an activation time of a PDCCH monitoring adaptation indication received by the UE. FIG. 9A depicts a single stage DCI carrying the adaptation indication, while FIG. 9B depicts a first stage DCI carrying the adaptation indication.

As shown in FIG. 9A, a single stage DCI 910, transmitted by a network entity 902 (e.g., such as BS 102 in FIGS. 1 and 3) to a UE 904 (e.g., such as UE 104 in FIGS. 1 and 3), is used to carry an indication 906. Single stage DCI 910 may be received by UE 904 after UE 904 receives a first stage DCI 912, but before UE 904 receives a second stage DCI associated with first stage DCI 912. Indication 906, included in single stage DCI 910, indicates that UE 904 is to stop monitoring PDCCH monitoring occasions 920(1)-(3) that UE 904 was previously scheduled to monitor. Based on receiving indication 906 in single stage DCI 910 and after an activation time 905 of indication 906, UE 904 monitors at least PDCCH monitoring occasion 920(1), and in some cases, stops monitoring PDCCH monitoring occasions 920(2) and 920(3), or monitors one or more of PDCCH monitoring occasions 920(2) and 920(3).

For example, indication 906 may comprise a PDCCH skipping command for a time period after the activation time 905 of the indication 906; thus, PDCCH monitoring occasions 920(1)-(3), which UE 904 is instructed to stop monitoring, may be PDCCH monitoring occasions scheduled during the time period after the activation time 905 of the indication 906. Based on receiving indication 906 in single stage DCI 910, UE 904 monitors at least PDCCH monitoring occasion 920(1) occurring during the time period (e.g., associated with a second stage DCI), and in some cases, stops monitoring PDCCH monitoring occasions 920(2) and 920(3), or monitors one or more of PDCCH monitoring occasions 920(2) and 920(3) also occurring the during time period.

As another example, indication 906 may comprise an SSSG switching command indicating to switch from a first SSSG to a second SSSG; thus, PDCCH monitoring occasions 920(1)-(3), which UE 904 is instructed to stop monitoring, may be PDCCH monitoring occasions associated with the first SSSG. Based on receiving indication 906 in single stage DCI 910 and after an activation time 905 of indication 906, UE 904 monitors PDCCH monitoring occasion 920(1) associated with the first SSSG (e.g., associated with a second stage DCI), and in some cases, stops monitoring PDCCH monitoring occasions 920(2) and 920(3), or monitors one or more of PDCCH monitoring occasions 920(2) and 920(3) also associated with the first SSSG.

In some cases, PDCCH monitoring occasion 920(1) is associated with a second stage DCI associated with first stage DCI 912. Thus, by continuing to monitor at least PDCCH monitoring occasion 920(1), UE 904 may be able to receive at least one second stage DCI associated with the previously-received first stage DCI 912.

Unlike FIG. 9A, in FIG. 9B, indication 906 is transmitted to UE 904 via first stage DCI 912 (instead of single stage DCI 910). In some cases, first stage DCI 912, including indication 906, is received by UE 904 after receiving a single stage DCI 910. Although indication 906 is received in first stage DCI instead of single stage DCI 910 (e.g., as shown in FIG. 9A), UE behavior in response to receiving the indication 906 may be the same as FIG. 9A. In particular, based on receiving indication 906 and after an activation time 907 of indication 906, UE 904 monitors at least one PDCCH monitoring occasion 930 that UE 904 is instructed to stop monitoring via indication 906. In an example, UE 904 monitors at least PDCCH monitoring occasion 930(1) and stops monitoring one or more PDCCH monitoring occasions 930(2)-(3) that UE 904 is instructed to stop monitoring via indication 906.

In some cases, PDCCH monitoring occasion 930(1) is associated with a second stage DCI associated with first stage DCI 912. Thus, by continuing to monitor at least PDCCH monitoring occasion 930(1), UE 904 may be able to receive at least one second stage DCI associated with the previously-received first stage DCI 912.

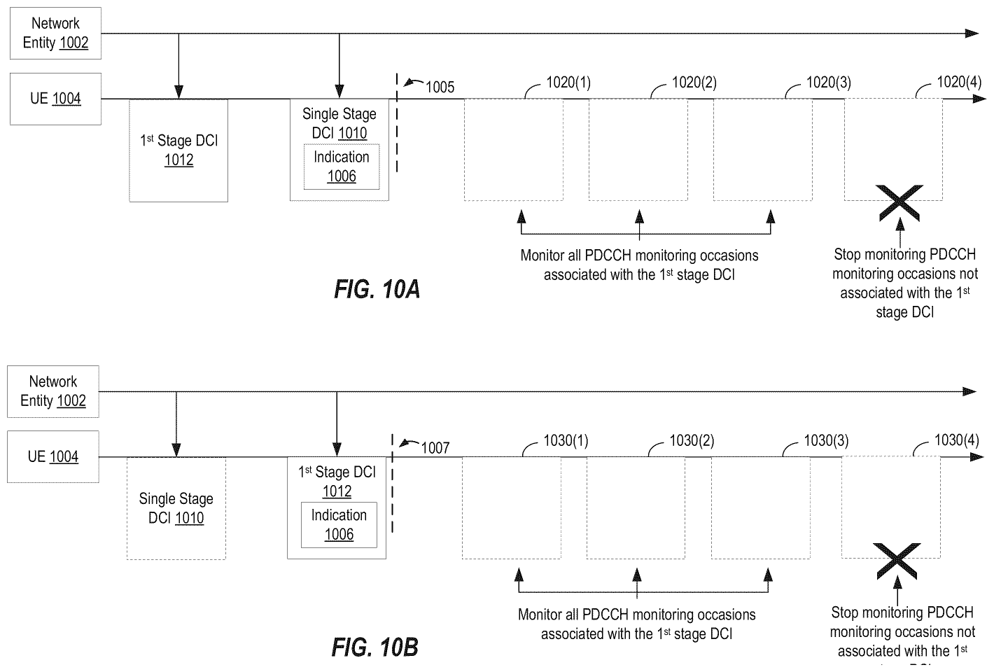

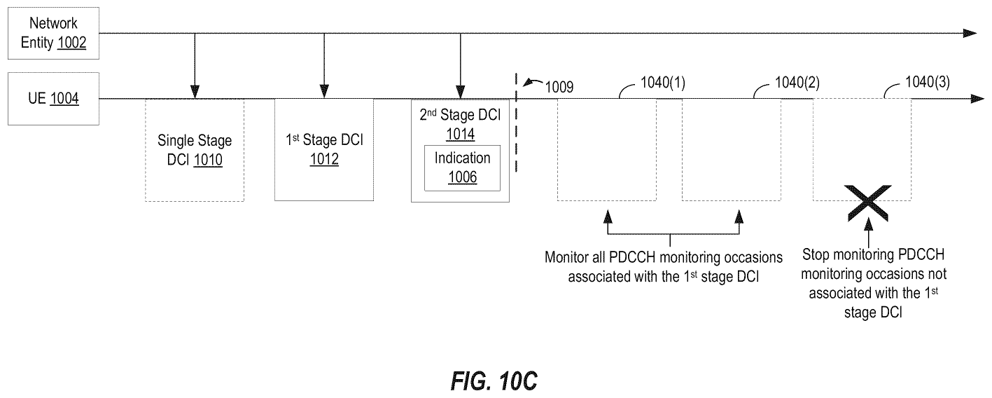

In some other embodiments, the at least one PDCCH monitoring occasion monitored by a UE (e.g., as shown in FIG. 8) after receiving a PDDCH monitoring adaptation indication includes all PDCCH monitoring occasions associated with a previously received (e.g., at a UE) first stage DCI and that occur a time after an activation time of the adaptation indication. FIGS. 10A-10C depict example PDCCH monitoring behavior of a UE adapted to monitor all PDCCH monitoring occasions associated with a first stage DCI of a two stage DCI after an activation time of a PDCCH monitoring adaptation indication received by the UE.

As shown in FIG. 10A, a single stage DCI 1010, transmitted by a network entity 1002 (e.g., such as BS 102 in FIGS. 1 and 3) to a UE 1004 (e.g., such as UE 104 in FIGS. 1 and 3), is used to carry an indication 1006. Single stage DCI 1010 may be received by UE 1004 after UE 1004 receives a first stage DCI 1012, but before UE 1004 receives a second stage DCI associated with first stage DCI 1012. Indication 1006, included in single stage DCI 1010, indicates that UE 1004 is to stop monitoring PDCCH monitoring occasions 1020(1)-(4) that UE 1004 was previously scheduled to monitor. Based on receiving indication 1006 in single stage DCI 1010 and after an activation time 1005 of indication 1006, UE 1004 monitors all PDCCH monitoring occasions 1020(1)-1020(3) associated with first stage DCI 1012 (and occurring in time after activation time 1005 of indication 1006) and stops monitoring any PDCCH monitoring occasion 1020(4) not associated with first stage DCI 1012 (and occurring in time after activation time 1005 of indication 1006).

For example, indication 1006 may comprise a PDCCH skipping command for a time period after the activation time 1005 of indication 1006; thus, PDCCH monitoring occasions 1020(1)-(4), which UE 1004 is instructed to stop monitoring, may be PDCCH monitoring occasions scheduled during the time period after the activation time 1005 of indication 1006. PDCCH monitoring occasions 1020(1)-(3) may be monitoring occasions associated with first stage DCI 1012, but monitoring occasion 1020(4) may not be associated with first stage DCI 1012. In other words, PDCCH monitoring occasions 1020(1)-(3) may be monitoring occasions for receiving multiple second stage DCI associated with the single first stage DCI 1012. Based on receiving indication 1006 in single stage DCI 1010 and after the activation time 1005 of indication 1006, UE 1004 monitors PDCCH monitoring occasions 1020(1)-(3) occurring during the time period and associated with first stage DCI 1012 (e.g., all PDCCH monitoring occasions associated with first stage DCI 1012 occurring after the activation time 1005 of indication 1006), and stops monitoring PDCCH monitoring occasions 1020(4) also occurring the during time period, but not associated with first stage DCI 1012.

As another example, indication 1006 may comprise an SSSG switching command indicating to switch from a first SSSG to a second SSSG; thus, PDCCH monitoring occasions 1020(1)-(4), which UE 1004 is instructed to stop monitoring, may be PDCCH monitoring occasions associated with the first SSSG. Further, PDCCH monitoring occasions 1020(1)-(3) may be monitoring occasions associated with first stage DCI 1012, but monitoring occasion 1020(4) may not be associated with first stage DCI 1012. Based on receiving indication 1006 in single stage DCI 1010 and after the activation time 1005 of indication 1006, UE 1004 monitors PDCCH monitoring occasion 1020(1)-(3) associated with the first SSSG and associated with first stage DCI 1012 (e.g., all PDCCH monitoring occasions associated with first stage DCI 1012 occurring after the activation time 1005 of indication 1006), and stops monitoring PDCCH monitoring occasions 1020(4) also associated with the first SSSG, but not associated with first stage DCI 1012.

By continuing to monitor all PDCCH monitoring occasions 1020(1)-(3) associated with the first stage DCI and occurring in time after the activation time 1005 of indication 1006, UE 1004 may be able to receive all second stage DCI associated with the previously-received first stage DCI 1012.

Unlike FIG. 10A, in FIG. 10B, indication 1006 is transmitted to UE 1004 via first stage DCI 1012 (instead of single stage DCI 1010). In some cases, first stage DCI 1012, including indication 1006, is received by UE 1004 after receiving a single stage DCI 1010. Although indication 1006 is received in first stage DCI 1012 instead of single stage DCI 1010 (e.g., as shown in FIG. 10A), UE behavior in response to receiving the indication 1006 may be the same as FIG. 10A. In particular, indication 1006, included in first stage DCI 1012, indicates that UE 1004 is to stop monitoring PDCCH monitoring occasions 1030(1)-(4) that UE 1004 was previously scheduled to monitor. Based on receiving indication 1006 in first stage DCI 1012, UE 1004 monitors all PDCCH monitoring occasions 1030(1)-(3) associated with first stage DCI 1012 (and occurring in time after an activation time 1007 of indication 1006) and stops monitoring any PDCCH monitoring occasion 1030(4) not associated with first stage DCI 1012 (and occurring in time after the activation time 1007 of indication 1006).

Again, by continuing to monitor all PDCCH monitoring occasions 1030(1)-(3) associated with the first stage DCI 1012 and occurring in time after the activation time 1007 of indication 1006, UE 1004 may be able to receive all second stage DCI associated with the previously-received first stage DCI 1012.

Unlike FIGS. 10A and 10B, in FIG. 10C, indication 1006 is transmitted to UE 1004 via second stage DCI 1014 (instead of single stage DCI 1010 or first stage DCI 1012). Second stage DCI 1014, including indication 1006, is received by UE 1004 after receiving first stage DCI 1012 (e.g., where second stage DCI is associated with first stage DCI 1012). In some cases, second stage DCI 1014, including indication 1006, is received by UE 1004 after also receiving a single stage DCI 1010. Although indication 1006 is received in second stage DCI 1014 instead of single stage DCI 1010 (e.g., as shown in FIG. 10A) or first stage DCI 1012 (e.g., as shown in FIG. 10B), UE behavior in response to receiving the indication 1006 may be the same as FIGS. 10A and 10B, or similar to FIGS. 9A and 9B. In particular, indication 1006, included in first stage DCI 1012, indicates that UE 1004 is to stop monitoring PDCCH monitoring occasions 1040(1)-(3) that UE 1004 was previously scheduled to monitor. Based on receiving indication 1006 in second stage DCI 1014 (e.g., in this example, a first-in-time second stage DCI associated with first stage DCI 1012), UE 1004 monitors one or more (e.g., all) PDCCH monitoring occasions 1040(1)-(2) associated with first stage DCI 1012 and occurring in time after receiving indication 1006 and stops monitoring any PDCCH monitoring occasion 1040(3) not associated with first stage DCI 1012 and occurring in time after an activation time 1009 of indication 1006. In this example, one or more of PDCCH monitoring occasions 1040(1)-(2) may be used to receive additional second stage DCIs associated with first stage DCI (e.g., excluding the first-in-time second stage DCI associated with first stage DCI 1012, e.g., second stage DCI 1014).

Again, by continuing to monitor one or more (e.g., all) PDCCH monitoring occasions 1040(1)-(2) associated with the first stage DCI 1012 and occurring in time after the activation time 1009 for indication 1006, UE 1004 may be able to receive second stage DCI associated with the previously-received first stage DCI 1012.

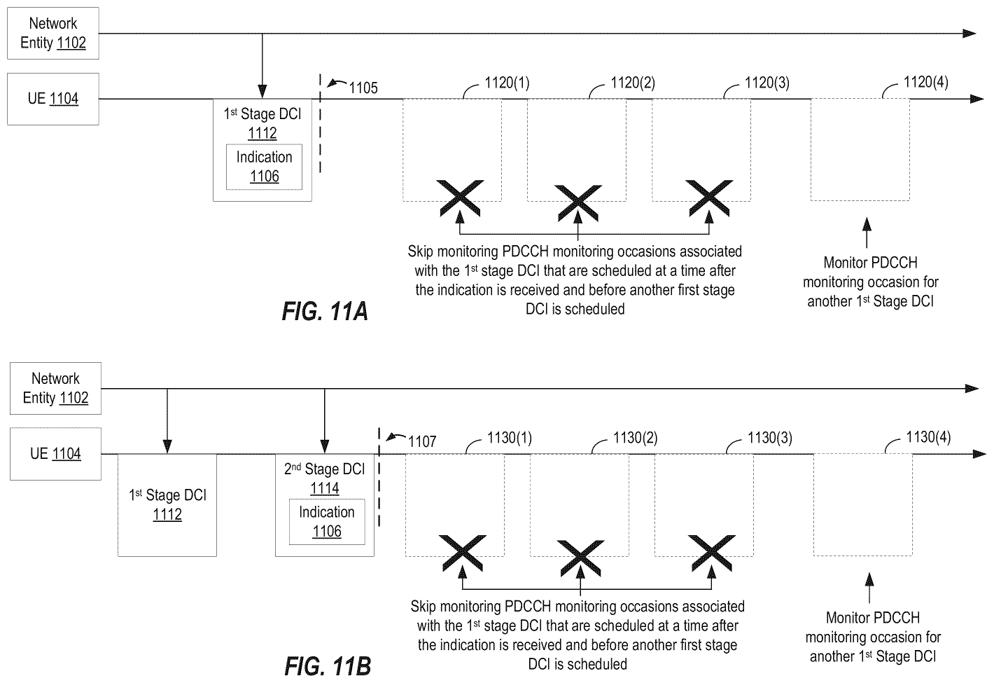

In certain aspects where the PDCCH monitoring adaptation indication is carried by a first stage DCI or a second stage DCI of a two stage DCI and the first stage DCI is associated with multiple second stage DCIs, other UE behavior may be considered. For example, as shown in FIGS. 11A and 11B, after an activation time of a PDCCH monitoring adaptation indication received by a UE, the UE may (1) stop monitoring one or more PDCCH monitoring occasions associated with the first stage DCI that are scheduled at a time after a time when the adaptation indication is received and activated but (2) resumes PDCCH monitoring to monitor at least a PDCCH monitoring occasion associated with another first stage DCI of another two stage DCI.

In particular, as shown in FIG. 11A, a first stage DCI 1112 of a two stage DCI, transmitted by a network entity 1102 (e.g., such as BS 102 in FIGS. 1 and 3) to a UE 1104 (e.g., such as UE 104 in FIGS. 1 and 3), is used to carry an indication 1106. Although not shown, in some cases, first stage DCI 1112 is received by UE 1104 after UE 1104 receives a single stage DCI. Indication 1106, included in first stage DCI 1112, indicates that UE 1104 is to stop monitoring PDCCH monitoring occasions 1120(1)-(4) that UE 1004 was previously scheduled to monitor after an activation time 1105 for the indication 1106. For example, indication 1106 may be a PDCCH skipping command indicating that UE 1104 is to stop monitoring PDCCH monitoring occasions 1120(1)-(4) because these monitoring occasions occur during a time period after the activation time 1105 for indication 1106. In this example, PDCCH monitoring occasions 1120(1)-(3) are associated with second stage DCI of the two stage DCI (e.g., are associated with first stage DCI 1112), and PDCCH monitoring occasion 1120(4) is associated with another first stage DCI of another two stage DCI.

Based on receiving indication 1106 in first stage DCI 1112 and after the activation time 1105 of indication 1106, UE 1104 skips monitoring PDCCH monitoring occasions 1120(1)-(3) (e.g., PDCCH monitoring occasions associated with second stage DCI of the two stage DCI and that are scheduled after the activation time 1105 of indication 1106), but monitors PDCCH monitoring occasion 1120(4) because this PDCCH monitoring occasion 1120(4) is associated with another first stage DCI of another two stage DCI (e.g., a next-in-time first stage DCI of another two stage DCI). In other words, the periodic duration pattern of two stage DCI monitoring may be used to implicitly indicate the PDCCH monitoring occasion skipping duration for UE 1104.

Unlike FIG. 11A, in FIG. 11B, indication 1106 is transmitted to UE 1104 in a second stage DCI 1114 (instead of first stage DCI 1112) via a PDCCH. Second stage DCI 1114, including indication 1106, is received by UE 1004 after receiving first stage DCI 1112 (e.g., where second stage DCI 1114 is associated with first stage DCI 1112 and both DCI belong to the same two stage DCI). In some cases, second stage DCI 1114, including indication 1106, is received by UE 1104 after also receiving a single stage DCI (not shown in FIG. 11B). Although indication 1106 is received in second stage DCI 1114 instead of first stage DCI 1112 (e.g., as shown in FIG. 11A), UE behavior in response to receiving the indication 1106 may be the same as FIG. 11A. In particular, after an activation time 1107 of indication 1106, UE 1104 may skip monitoring PDCCH monitoring occasions associated with second stage DCI of the two stage DCI (e.g., where first stage DCI 1112 of the two stage DCI is associated with multiple second stage DCI) but monitor a PDCCH monitoring occasion for a next-in-time first stage DCI of another two stage DCI. For example, based on receiving indication 1106 in second stage DCI 1114 and after the activation time 1107 of indication 1106, UE 1104 skips monitoring PDCCH monitoring occasions 1130(1)-(3) (e.g., PDCCH monitoring occasions associated with second stage DCI of the two stage DCI and that are scheduled after an activation time of indication 1106), but monitors PDCCH monitoring occasion 1120(4) because this PDCCH monitoring occasion 1120(4) is associated with another first stage DCI of another two stage DCI.

Adaptation behavior of UE 1104 illustrated in FIGS. 11A and 11B may be useful in cases where UE 1104 is not configured with connected mode discontinuous reception (C-DRX). C-DRX is a technique used to improve UE battery consumption by allowing a UE to periodically enter a “sleep” state (e.g., during a DRX OFF duration) during which PDCCH need not be monitored. In order to monitor PDCCH, the UE is allowed to transition to an “awake” state periodically, when configured with C-DRX, and stay “awake” for a certain amount of time (e.g., a DRX ON duration) before returning to the “sleep” state.

In some cases, a UE may (1) stop monitoring all PDCCH monitoring occasions (e.g., including PDCCH monitoring occasions associated with two stage DCI and single stage DCI) that are scheduled at a time after a time when an adaptation indication is received and activated, and (2) resume PDCCH monitoring to monitor at least a PDCCH monitoring occasion associated with another first stage DCI of another two stage DCI. This is similar to the examples illustrated in FIGS. 11A and 11B; however, all PDCCHs that schedule user data (and are scheduled at a time after a time when the adaptation indication is received and activated) may be skipped, instead of only PDCCH monitoring occasions associated with second stage DCI of a two stage DCI. In such cases, the UE stops monitoring any PDCCH that is subject to the adaptation indication (e.g., the PDCCH skipping command) scheduled during a time (1) after the activation of the adaptation indication but (2) before a PDCCH monitoring occasion for a next-in-time first stage DCI of another two stage DCI. This may be particularly useful in cases where monitoring of first stage DCIs is aligned with the start of data cycles for periodic traffic, when C-DRX is not enabled.

In some cases, first stage DCI and second stage DCI of a two stage DCI may be associated with different SSSs. For example, first stage DCI may be scheduled during PDCCH monitoring occasions of a first SSS, while second stage DCI may be scheduled during PDCCH monitoring occasions of a second SSS. Certain aspects herein ensure that a UE, when configured to monitor an SSS of one of a first stage DCI or second stage DCI of a two stage DCI, is also configured to monitor the an SSS of the other of the first stage DCI or the second stage DCI of the two stage DCI, so that the UE receives both the first stage and second stage DCI of the two stage DCI. For example, if the UE is configured to monitor the first SSS, the UE is also configured to monitor the second SSS, and vice versa (if configured to monitor the second SSS, the UE is also configured to monitor the first SSS).

Certain aspects, provide that SSSs for both first and second stage DCIs are configured within the same SSSG, so that PDCCH monitoring adaptation indication explicitly switches SSSs for both the first and second stage DCIs simultaneously. For example, both the first SSS and second SSS would be part of the same SSSG.

Certain aspects provide that the SSS associated with the first stage DCI and the SSS associated with the second stage DCI may not be part of the same SSSG. For example, an SSSG may include the first SSS and not the second SSS. As another example, an SSSG may include the second SSS and not the first SSS. In certain such aspects, if the UE is configured with (e.g., switched to) a particular SSSG and the SSSG includes an SSS of one but not the other of the first stage DCI and the second stage DCI, the UE may implicitly monitor the other of the first stage DCI and the second stage DCI. For example, where the SSSG includes the first SSS and not the second SSS, the UE may still monitor for the second SSS. Further, where the SSSG includes the second SSS and not the first 88S, the UE may still monitor for the first SSS.

Accordingly, in certain aspects, where the UE switches away from such an SSSG, the UE may stop monitoring both the SSS of the two stage DCI included in the SSSG as well as the SSS of the two stage DCI not included in the SSSG. For example, where the SSSG includes the first SSS and not the second SSS, the UE may stop monitoring both the first SSS and the second SSS. Further, where the SSSG includes the second SSS and not the first SSS, the UE may stop monitoring both the first SSS and the second SSS.

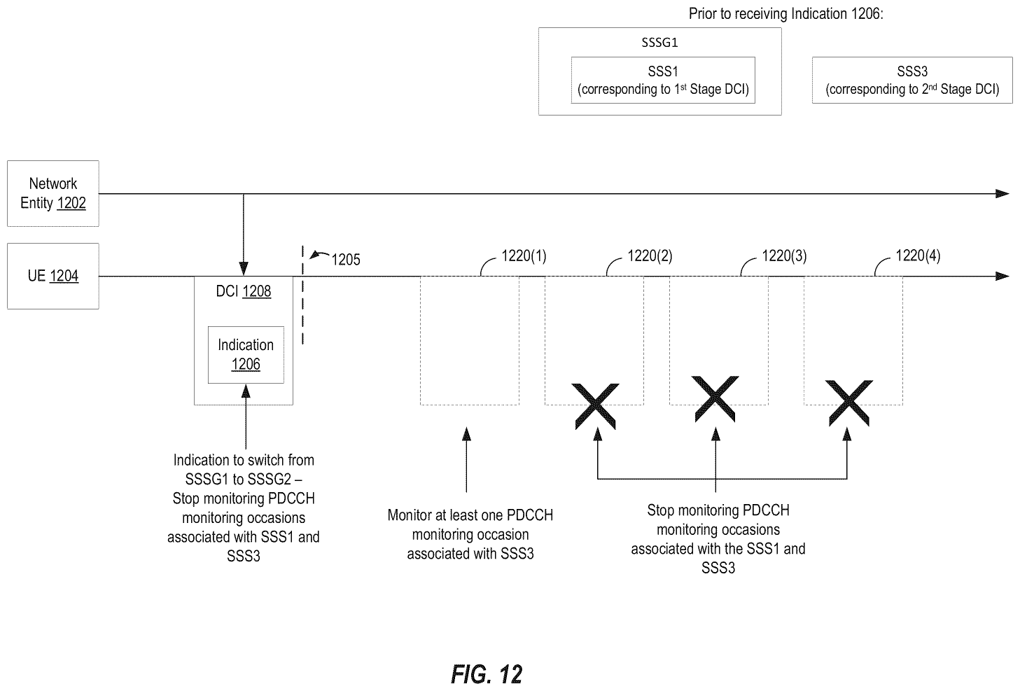

FIG. 12 depicts example adapted PDCCH monitoring behavior of a UE after an activation time for a PDCCH monitoring adaptation indication for SSSG switching received by the UE. As shown, a network entity 1202 (e.g., such as BS 102 in FIGS. 1 and 3) transmits, to a UE 1204 (e.g., such as UE 104 in FIGS. 1 and 3), a DCI 1208 scheduling a data transmission (e.g., an uplink data transmission or a downlink data transmission, not shown in FIG. 12). DCI 1208 may be a single stage DCI, a first stage DCI, or a second stage DCI. In some cases, DCI 1208 is a single stage DCI received by UE 1204 after receiving a first stage DCI, but before receiving a second stage DCI associated with the previously-received first stage DCI.

DCI 1208 includes an indication 1206 comprising an SSSG switching indication indicating that UE 1204 (e.g., after an activation time 1205 of indication 1206) is to switch from a first SSSG (SSSG1) to a second SSSG (SSSG2), or in other words, stop monitoring PDCCH monitoring occasions associated with SSSG1.

In this example, prior to receiving indication 1206, UE 1204 is configured to monitor for first stage DCI of a two stage DCI in a first SSS (SSS1) and monitor for second stage DCI of the two stage DCI in a third SSS (SSS3). SSSG1 includes SSS1 (e.g., corresponding to the first stage DCI) but not SSS3.

According to aspects described herein, indication 1206 indicating to switch from SSSG1 to SSSG2 (not including SSS1 or SSS3, but including SSS2, for example), may cause UE 1204 to not only stop monitoring PDCCH monitoring occasions (e.g., 1220(2)-1220(4)) associated with SSS1, belonging to SSSG1, but also PDCCH monitoring occasions associated with SSS3. In some cases, UE 1204 may immediately stop monitoring such PDCCH monitoring occasions associated with SSS1 and SSS3. In some cases, as discussed, UE 1204 may monitor at least one PDCCH monitoring occasion 1220(1) associated with SSS3, after the activation time 1205 of indication 1206. In some cases, this involves UE 1204 monitoring all PDCCH monitoring occasions (although not explicitly shown in FIG. 12) associated with SSS3 and associated with a previously-received first stage DCI, to receive all second stage DCI associated with the previously-received first stage DCI (e.g., that are also associated with SSS3).

### Example Operations of a User Equipment

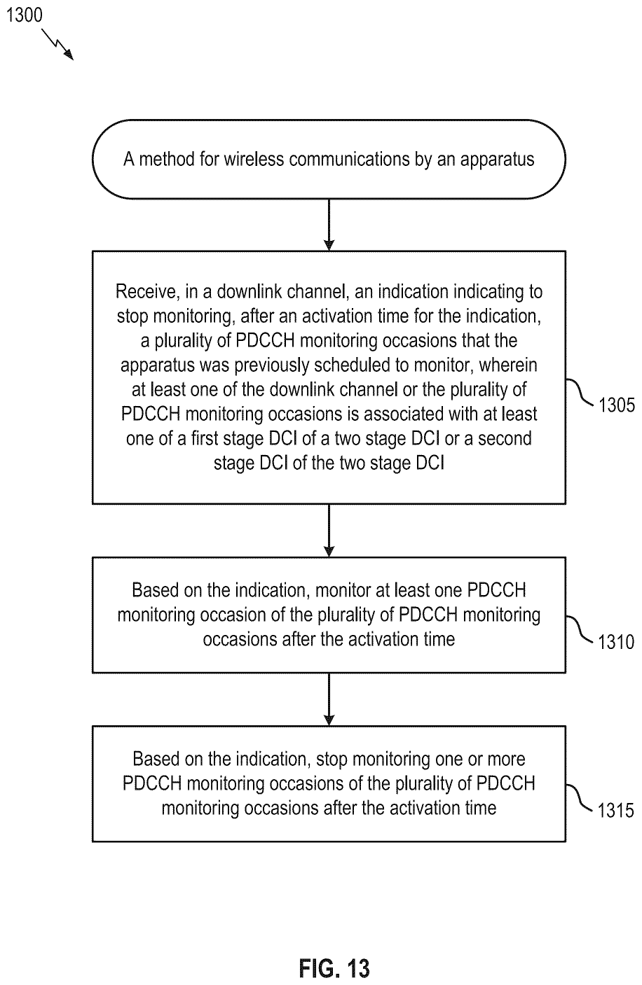

FIG. 13 shows a method 1300 for wireless communications by an apparatus, such as UE 104 of FIGS. 1 and 3.

Method 1300 begins at step 1305 with receiving, in a downlink channel, an indication indicating to stop monitoring, after an activation time for the indication, a plurality of PDCCH monitoring occasions that the apparatus was previously scheduled to monitor. For example, as discussed with respect to FIGS. 8, 9A-9B, 10A-10C, 11A-11B, and 12, a UE (e.g., UE 804, 904, 1004, 1104, 1204, respectively) receives an indication (e.g., indication 806, 906, 1006, 1106, 1206, respectively) in a PDCCH. The indication may be a PDCCH skipping command instructing the UE to skip PDCCH monitoring for a specific duration after an activation time (e.g., activation time 805, 905, 907, 1005, 1007, 1009, 1105, 1107, 1205, respectively) for the indication or an SSSG command indicating that the UE is to switch from monitoring a first SSSG to monitoring a second SSSG after the activation time. In other words, the indication may be a command instructing the UE to stop monitoring, after the activation time for the indication, PDCCH monitoring occasions (e.g., PDCCH monitoring occasions 820(1)-(4), 920(1)-(3), 930(1)-(3), 1020(1)-(4), 1030(1)-(4), 1040(1)-(3), 1120(1)-(4), 1130(1)-(4), 1220(1)-(4), respectively), which are scheduled during the indicated time period or are not associated with the second SSSG. At least one of the downlink channel or the plurality of PDCCH monitoring occasions may be associated with at least one of a first stage DCI of a two stage DCI or a second stage DCI of the two stage DCI. For example, as discussed with respect to FIGS. 9B, 10B, and 11A, the downlink channel may be associated with a first stage DCI 912, 1012, 1112, respectively. Additionally, as discussed with respect to FIGS. 10C and 11B, the downlink channel may be associated with a second stage DCI 1014, 1114, respectively. Additionally, as discussed with respect to FIGS. 8, 9A-9B, 10A-10C, 11A-11B, and 12, PDCCH monitoring occasions 820(1)-(4), 920(1)-(3), 930(1)-(3), 1020(1)-(4), 1030(1)-(4), 1040(1)-(3), 1120(1)-(4), 1130(1)-(4), 1220(1)-(4), respectively, may be associated with at least one of a first stage DCI or a second stage DCI of a two stage DCI.

Method 1300 then proceeds to step 1310 with, based on the indication, monitoring at least one PDCCH monitoring occasion of the plurality of PDCCH monitoring occasions after the activation time. For example, as discussed with respect to FIGS. 8, 9A-9B, 10A-10C, 11A-11B, and 12, UE 804, 904, 1004, 1104, 1204, respectively, is instructed, based on indication 806, 906, 1006, 1106, 1206, respectively, to stop monitoring PDCCH monitoring occasions 820(1)-(4), 920(1)-(3), 930(1)-(3), 1020(1)-(4), 1030(1)-(4), 1040(1)-(3), 1120(1)-(4), 1130(1)-(4), 1220(1)-(4), respectively, but continues to monitor PDCCH monitoring occasion(s) 820(1), 920(1), 930(1), 1020(1)-(3), 1030(1)-(3), 1040(1)-(2), 1120(4), 1130(4), 1220(4), respectively.

Method 1300 then proceeds to step 1315 with, based on the indication, stopping monitoring one or more PDCCH monitoring occasions of the plurality of PDCCH monitoring occasions after the activation time. For example, as discussed with respect to FIGS. 8, 9A-9B, 10A-10C, 11A-11B, and 12, UE 804, 904, 1004, 1104, 1204, respectively, is instructed, based on indication 806, 906, 1006, 1106, 1206, respectively, to stop monitoring PDCCH monitoring occasions 820(1)-(4), 920(1)-(3), 930(1)-(3), 1020(1)-(4), 1030(1)-(4), 1040(1)-(3), 1120(1)-(4), 1130(1)-(4), 1220(1)-(4), respectively, and stops monitoring PDCCH monitoring occasion(s) 820(2)-(4), 920(2)-(3), 930(2)-(3), 1020(4), 1030(4), 1040(3), 1120(1)-(3), 1130(1)-(3), 1220(2)-(4), respectively.

In certain aspects, the indication comprises a PDCCH skipping command for a time period the plurality of PDCCH monitoring occasions are scheduled during the time period.

In certain aspects, the indication comprises a SSSG switching command indicating to switch from a first SSSG to a second SSSG the plurality of PDCCH monitoring occasions are associated with the first SSSG.

In certain aspects, the first SSSG includes a first SSS the second SSSG does not include the first SSS the plurality of PDCCH monitoring occasions are associated with the first SSS.

In certain aspects, the first SSSG includes a first SSS corresponding to one of the first stage DCI or the second stage DCI and does not include a second SSS corresponding to the other one of the first stage DCI or the second stage DCI, and wherein the SSSG switching command indicates to stop monitoring PDCCH monitoring occasions associated with the first SSS and PDCCH monitoring occasions associated with the second SSS.

In certain aspects, method 1300 further includes receiving the first stage DCI.

In certain aspects, monitoring the at least one PDCCH monitoring occasion of the plurality of PDCCH monitoring occasions comprises monitoring at least one PDCCH monitoring occasion for the second stage DCI associated with the first stage DCI that is scheduled after receiving the indication.

In certain aspects, the at least one PDCCH monitoring occasion associated with the first stage DCI comprises all PDCCH monitoring occasions for the second stage DCI associated with the first stage DCI that are scheduled after receiving the indication.

In certain aspects, receiving the indication comprises receiving the indication in the first stage DCI or the second stage DCI monitoring the at least one PDCCH monitoring occasion of the plurality of PDCCH monitoring occasions comprises monitoring a PDCCH monitoring occasion associated with another first stage DCI of another two stage DCI stopping monitoring the one or more PDCCH monitoring occasions comprises stopping monitoring the one or more PDCCH monitoring occasions associated with the first stage DCI that are scheduled after the activation time for the indication and before a second time the other first stage DCI is scheduled.

In certain aspects, method 1300 further includes receiving the indication in the first stage DCI or the second stage DCI, wherein monitoring the at least one PDCCH monitoring occasion of the plurality of PDCCH monitoring occasions comprises monitoring PDCCH monitoring occasions associated with a single stage DCI.

In certain aspects, receiving the indication comprises receiving the indication in at least one of: the first stage DCI the second stage DCI.

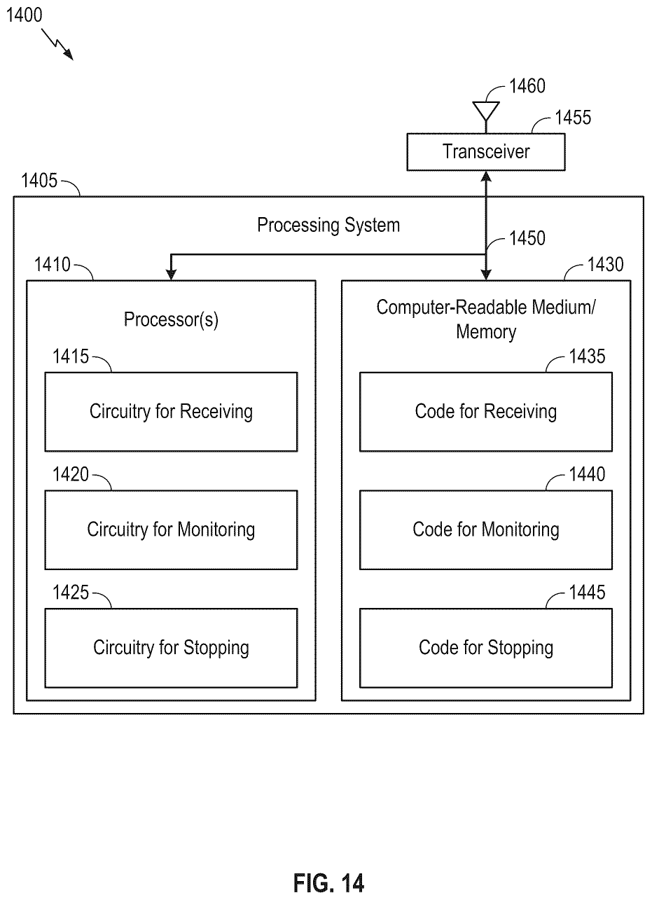

In certain aspects, method 1300, or any aspect related to it, may be performed by an apparatus, such as communications device 1400 of FIG. 14, which includes various components operable, configured, or adapted to perform the method 1300. Communications device 1400 is described below in further detail.

Note that FIG. 13 is just one example of a method, and other methods including fewer, additional, or alternative steps are possible consistent with this disclosure.

### Example Communications Devices

FIG. 14 depicts aspects of an example communications device 1400. In some aspects, communications device 1400 is a user equipment, such as UE 104 described above with respect to FIGS. 1 and 3.

The communications device 1400 includes a processing system 1405 coupled to a transceiver 1455 (e.g., a transmitter and/or a receiver). The transceiver 1455 is configured to transmit and receive signals for the communications device 1400 via an antenna 1460, such as the various signals as described herein. The processing system 1405 may be configured to perform processing functions for the communications device 1400, including processing signals received and/or to be transmitted by the communications device 1400.

The processing system 1405 includes one or more processors 1410. In various aspects, the one or more processors 1410 may be representative of one or more of receive processor 358, transmit processor 364, TX MIMO processor 366, and/or controller/processor 380, as described with respect to FIG. 3. The one or more processors 1410 are coupled to a computer-readable medium/memory 1430 via a bus 1450. In certain aspects, the computer-readable medium/memory 1430 is configured to store instructions (e.g., computer-executable code) that when executed by the one or more processors 1410, enable and cause the one or more processors 1410 to perform the method 1300 described with respect to FIG. 13, or any aspect related to it, including any additional steps or sub-steps described in relation to FIG. 13. Note that reference to a processor performing a function of communications device 1400 may include one or more processors performing that function of communications device 1400, such as in a distributed fashion.

In the depicted example, computer-readable medium/memory 1430 stores code for receiving 1435, code for monitoring 1440, and code for stopping 1445. Processing of the code 1435-1445 may enable and cause the communications device 1400 to perform the method 1300 described with respect to FIG. 13, or any aspect related to it.

The one or more processors 1410 include circuitry configured to implement (e.g., execute) the code stored in the computer-readable medium/memory 1430, including circuitry for receiving 1415, circuitry for monitoring 1420, and circuitry for stopping 1425. Processing with circuitry 1415-1425 may enable and cause the communications device 1400 to perform the method 1300 described with respect to FIG. 13, or any aspect related to it.

More generally, means for communicating, transmitting, sending or outputting for transmission may include the transceivers 354, antenna(s) 352, transmit processor 364, TX MIMO processor 366, and/or controller/processor 380 of the UE 104 illustrated in FIG. 3, transceiver 1455 and/or antenna 1460 of the communications device 1400 in FIG. 14, and/or one or more processors 1410 of the communications device 1400 in FIG. 14. Means for communicating, receiving or obtaining may include the transceivers 354, antenna(s) 352, receive processor 358, and/or controller/processor 380 of the UE 104 illustrated in FIG. 3, transceiver 1455 and/or antenna 1460 of the communications device 1400 in FIG. 14, and/or one or more processors 1410 of the communications device 1400 in FIG. 14.

### Example Clauses

Implementation examples are described in the following numbered clauses:

Clause 1: A method for wireless communications by an apparatus, comprising: receiving, in a downlink channel, an indication indicating to stop monitoring, after an activation time for the indication, a plurality of PDCCH monitoring occasions that the apparatus was previously scheduled to monitor, wherein at least one of the downlink channel or the plurality of PDCCH monitoring occasions is associated with at least one of a first stage DCI of a two stage DCI or a second stage DCI of the two stage DCI; based on the indication, monitoring at least one PDCCH monitoring occasion of the plurality of PDCCH monitoring occasions after the activation time; and based on the indication, stopping monitoring one or more PDCCH monitoring occasions of the plurality of PDCCH monitoring occasions after the activation time.

Clause 2: The method of Clause 1, wherein: the indication comprises a PDCCH skipping command for a time period; and the plurality of PDCCH monitoring occasions are scheduled during the time period.

Clause 3: The method of Clause 1, wherein: the indication comprises a SSSG switching command indicating to switch from a first SSSG to a second SSSG; and the plurality of PDCCH monitoring occasions are associated with the first SSSG.

Clause 4: The method of Clause 3, wherein: the first SSSG includes a first SSS; the second SSSG does not include the first SSS; and the plurality of PDCCH monitoring occasions are associated with the first SSS.

Clause 5: The method of Clause 3, wherein the first SSSG includes a first SSS corresponding to one of the first stage DCI or the second stage DCI and does not include a second SSS corresponding to the other one of the first stage DCI or the second stage DCI, and wherein the SSSG switching command indicates to stop monitoring PDCCH monitoring occasions associated with the first SSS and PDCCH monitoring occasions associated with the second SSS.

Clause 6: The method of any one of Clauses 1-5, further comprising receiving the first stage DCI.

Clause 7: The method of Clause 6, wherein monitoring the at least one PDCCH monitoring occasion of the plurality of PDCCH monitoring occasions comprises monitoring at least one PDCCH monitoring occasion for the second stage DCI associated with the first stage DCI that is scheduled after receiving the indication.

Clause 8: The method of Clause 7, wherein the at least one PDCCH monitoring occasion associated with the first stage DCI comprises all PDCCH monitoring occasions for the second stage DCI associated with the first stage DCI that are scheduled after receiving the indication.

Clause 9: The method of any one of Clauses 1-6, wherein receiving the indication comprises receiving the indication in the first stage DCI or the second stage DCI; monitoring the at least one PDCCH monitoring occasion of the plurality of PDCCH monitoring occasions comprises monitoring a PDCCH monitoring occasion associated with another first stage DCI of another two stage DCI; and stopping monitoring the one or more PDCCH monitoring occasions comprises stopping monitoring the one or more PDCCH monitoring occasions associated with the first stage DCI that are scheduled after the activation time for the indication and before a second time the other first stage DCI is scheduled.

Clause 10: The method of any one of Clauses 1-9, further comprising: and receiving the indication in the first stage DCI or the second stage DCI, wherein monitoring the at least one PDCCH monitoring occasion of the plurality of PDCCH monitoring occasions comprises monitoring PDCCH monitoring occasions associated with a single stage DCI.

Clause 11: The method of any one of Clauses 1-10, wherein receiving the indication comprises receiving the indication in at least one of: the first stage DCI; or the second stage DCI.

Clause 12: One or more apparatuses, comprising: one or more memories (e.g., comprising executable instructions); and one or more processors (e.g., coupled to the one or more memories) configured to (e.g., execute the executable instructions and) cause the one or more apparatuses to perform a method in accordance with any one of clauses 1-11.

Clause 13: One or more apparatuses, comprising means for performing a method in accordance with any one of clauses 1-11.

Clause 14: One or more non-transitory computer-readable media comprising executable instructions that, when executed by one or more processors of one or more apparatuses, cause the one or more apparatuses to perform a method in accordance with any one of clauses 1-11.

Clause 15: One or more computer program products embodied on one or more computer-readable storage media comprising code for performing a method in accordance with any one of clauses 1-11.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising:
one or more memories; and
one or more processors, coupled to the one or more memories, configured to cause the apparatus to:
receive, in a downlink channel, an indication indicating to stop monitoring, after an activation time for the indication, a plurality of physical downlink control channel (PDCCH) monitoring occasions that the apparatus was previously scheduled to monitor, wherein at least one of the downlink channel or the plurality of PDCCH monitoring occasions is associated with at least one of a first stage downlink control information (DCI) of a two stage DCI or a second stage DCI of the two stage DCI;
based on the indication, monitor at least one PDCCH monitoring occasion of the plurality of PDCCH monitoring occasions after the activation time; and
based on the indication, stop monitoring one or more PDCCH monitoring occasions of the plurality of PDCCH monitoring occasions after the activation time.

2. The apparatus of claim 1, wherein:
the indication comprises a PDCCH skipping command for a time period; and
the plurality of PDCCH monitoring occasions are scheduled during the time period.

3. The apparatus of claim 1, wherein:
the indication comprises a search space set group (SSSG) switching command indicating to switch from a first SSSG to a second SSSG; and
the plurality of PDCCH monitoring occasions are associated with the first SSSG.

4. The apparatus of claim 3, wherein:
the first SSSG includes a first search space set (SSS);
the second SSSG does not include the first SSS; and
the plurality of PDCCH monitoring occasions are associated with the first SSS.

5. The apparatus of claim 3, wherein the first SSSG includes a first search space set (SSS) corresponding to one of the first stage DCI or the second stage DCI and does not include a second SSS corresponding to the other one of the first stage DCI or the second stage DCI, and wherein the SSSG switching command indicates to stop monitoring PDCCH monitoring occasions associated with the first SSS and PDCCH monitoring occasions associated with the second SSS.

6. The apparatus of claim 1, wherein the one or more processors are configured to cause the apparatus to receive the first stage DCI.

7. The apparatus of claim 6, wherein to monitor the at least one PDCCH monitoring occasion of the plurality of PDCCH monitoring occasions, the one or more processors are configured to cause the apparatus to monitor at least one PDCCH monitoring occasion for the second stage DCI associated with the first stage DCI that is scheduled after receiving the indication.

8. The apparatus of claim 7, wherein the at least one PDCCH monitoring occasion associated with the first stage DCI comprises all PDCCH monitoring occasions for the second stage DCI associated with the first stage DCI that are scheduled after receiving the indication.

9. The apparatus of claim 1, wherein
to receive the indication, the one or more processors are configured to cause the apparatus to receive the indication in the first stage DCI or the second stage DCI;
to monitor the at least one PDCCH monitoring occasion of the plurality of PDCCH monitoring occasions, the one or more processors are configured to cause the apparatus to monitor a PDCCH monitoring occasion associated with another first stage DCI of another two stage DCI; and
to stop monitoring the one or more PDCCH monitoring occasions, the one or more processors are configured to cause the apparatus to stop monitoring the one or more PDCCH monitoring occasions associated with the first stage DCI that are scheduled after the activation time for the indication and before a second time the other first stage DCI is scheduled.

10. The apparatus of claim 1, wherein:
the one or more processors are configured to cause the apparatus to receive the indication in the first stage DCI or the second stage DCI; and
to monitor the at least one PDCCH monitoring occasion of the plurality of PDCCH monitoring occasions, the one or more processors are configured to cause the apparatus to monitor PDCCH monitoring occasions associated with a single stage DCI.

11. The apparatus of claim 1, wherein to receive the indication, the one or more processors are configured to cause the apparatus to receive the indication in at least one of:
the first stage DCI; or
the second stage DCI.

12. A method for wireless communications by an apparatus, comprising:
receiving, in a downlink channel, an indication indicating to stop monitoring, after an activation time for the indication, a plurality of physical downlink control channel (PDCCH) monitoring occasions that the apparatus was previously scheduled to monitor, wherein at least one of the downlink channel or the plurality of PDCCH monitoring occasions is associated with at least one of a first stage downlink control information (DCI) of a two stage DCI or a second stage DCI of the two stage DCI;
based on the indication, monitoring at least one PDCCH monitoring occasion of the plurality of PDCCH monitoring occasions after the activation time; and
based on the indication, stopping monitoring one or more PDCCH monitoring occasions of the plurality of PDCCH monitoring occasions after the activation time.

13. The method of claim 12, wherein:
the indication comprises a PDCCH skipping command for a time period; and
the plurality of PDCCH monitoring occasions are scheduled during the time period.

14. The method of claim 12, wherein:
the indication comprises a search space set group (SSSG) switching command indicating to switch from a first SSSG to a second SSSG; and
the plurality of PDCCH monitoring occasions are associated with the first SSSG.

15. The method of claim 14, wherein:
the first SSSG includes a first search space set (SSS);
the second SSSG does not include the first SSS; and
the plurality of PDCCH monitoring occasions are associated with the first SSS.

16. The method of claim 14, wherein the first SSSG includes a first search space set (SSS) corresponding to one of the first stage DCI or the second stage DCI and does not include a second SSS corresponding to the other one of the first stage DCI or the second stage DCI, and wherein the SSSG switching command indicates to stop monitoring PDCCH monitoring occasions associated with the first SSS and PDCCH monitoring occasions associated with the second SSS.

17. The method of claim 12, further comprising
receiving the first stage DCI.

18. The method of claim 17, wherein monitoring the at least one PDCCH monitoring occasion of the plurality of PDCCH monitoring occasions comprises monitoring at least one PDCCH monitoring occasion for the second stage DCI associated with the first stage DCI that is scheduled after receiving the indication.

19. The method of claim 18, wherein the at least one PDCCH monitoring occasion associated with the first stage DCI comprises all PDCCH monitoring occasions for the second stage DCI associated with the first stage DCI that are scheduled after receiving the indication.

20. The method of claim 12, wherein:
receiving the indication comprises receiving the indication in the first stage DCI or the second stage DCI;
monitoring the at least one PDCCH monitoring occasion of the plurality of PDCCH monitoring occasions comprises monitoring a PDCCH monitoring occasion associated with another first stage DCI of another two stage DCI; and
stopping monitoring the one or more PDCCH monitoring occasions comprises stopping monitoring the one or more PDCCH monitoring occasions associated with the first stage DCI that are scheduled after the activation time for the indication and before a second time the other first stage DCI is scheduled.

21. The method of claim 12, further comprising:
receiving the indication in the first stage DCI or the second stage DCI, wherein monitoring the at least one PDCCH monitoring occasion of the plurality of PDCCH monitoring occasions comprises monitoring PDCCH monitoring occasions associated with a single stage DCI.

22. The method of claim 12, wherein receiving the indication comprises receiving the indication in at least one of:
the first stage DCI; or
the second stage DCI.

23. An apparatus configured for wireless communications, comprising:
means for receiving, in a downlink channel, an indication indicating to stop monitoring, after an activation time for the indication, a plurality of physical downlink control channel (PDCCH) monitoring occasions that the apparatus was previously scheduled to monitor, wherein at least one of the downlink channel or the plurality of PDCCH monitoring occasions is associated with at least one of a first stage downlink control information (DCI) of a two stage DCI or a second stage DCI of the two stage DCI;
means for monitoring, based on the indication, at least one PDCCH monitoring occasion of the plurality of PDCCH monitoring occasions after the activation time; and
means for stopping monitoring, based on the indication, one or more PDCCH monitoring occasions of the plurality of PDCCH monitoring occasions after the activation time.

24. The apparatus of claim 23, wherein:
the indication comprises a PDCCH skipping command for a time period; and
the plurality of PDCCH monitoring occasions are scheduled during the time period.

25. The apparatus of claim 23, wherein:
the indication comprises a search space set group (SSSG) switching command indicating to switch from a first SSSG to a second SSSG; and
the plurality of PDCCH monitoring occasions are associated with the first SSSG.

26. The apparatus of claim 25, wherein:
the first SSSG includes a first search space set (SSS);
the second SSSG does not include the first SSS; and
the plurality of PDCCH monitoring occasions are associated with the first SSS.

27. The apparatus of claim 25, wherein the first SSSG includes a first search space set (SSS) corresponding to one of the first stage DCI or the second stage DCI and does not include a second SSS corresponding to the other one of the first stage DCI or the second stage DCI, and wherein the SSSG switching command indicates to stop monitoring PDCCH monitoring occasions associated with the first SSS and PDCCH monitoring occasions associated with the second SSS.

28. The apparatus of claim 23, further comprising means for receiving the first stage DCI.

29. The apparatus of claim 28, wherein means for monitoring the at least one PDCCH monitoring occasion of the plurality of PDCCH monitoring occasions comprises means for monitoring at least one PDCCH monitoring occasion for the second stage DCI associated with the first stage DCI that is scheduled after receiving the indication.

30. One or more non-transitory computer-readable media comprising executable instructions that, when executed by one or more processors of one or more apparatuses, cause the one or more apparatuses to perform operations comprising:
receiving, in a downlink channel, an indication indicating to stop monitoring, after an activation time for the indication, a plurality of physical downlink control channel (PDCCH) monitoring occasions that the one or more apparatuses were previously scheduled to monitor, wherein at least one of the downlink channel or the plurality of PDCCH monitoring occasions is associated with at least one of a first stage downlink control information (DCI) of a two stage DCI or a second stage DCI of the two stage DCI;
based on the indication, monitoring at least one PDCCH monitoring occasion of the plurality of PDCCH monitoring occasions after the activation time; and
based on the indication, stopping monitoring one or more PDCCH monitoring occasions of the plurality of PDCCH monitoring occasions after the activation time.
